(19) United States
(12) Patent Application Publication
(10) Pub. No.: US 2026/0127716 A1
(43) Pub. Date: May 7, 2026

(54) LOW-LIGHT IMAGE ENHANCEMENT AND IMAGE RECTIFICATION SYSTEMS AND METHODS

(71) Applicant: FLIR Systems AB, Täby (SE)

(72) Inventor: Martin Solli, Tullinge (SE)

(21) Appl. No.: 19/437,103

(22) Filed: Dec. 30, 2025

Related U.S. Application Data
(63) Continuation-in-part of application No. PCT/US2025/046807, filed on Sep. 17, 2025.
(60) Provisional application No. 63/698,542, filed on Sep. 24, 2024.
(60) Provisional application No. 63/740,629, filed on Dec. 31, 2024.

(51) Int. Cl. G06T 5/50; G06T 5/60; G06T 5/70

(52) U.S. Cl. CPC G06T 5/50; G06T 5/60; G06T 5/70; G06T 2207/10024; G06T 2207/10048; G06T 2207/20081; G06T 2207/20084; G06T 2207/20221

(57) ABSTRACT

Techniques for image enhancement are disclosed. A method includes receiving an image pair of a scene, the image pair comprising a visible light (VIS) image of the scene captured using a VIS imaging device and an infrared (IR) image of the scene captured using an IR imaging device. The method may further include generating a combined image based on the image pair, wherein the combined image comprises one or more quality characteristics. The method may also include adjusting one or more components of at least a portion of the VIS image based on the one or more quality characteristics of the combined image. The method may also include generating an enhanced combined image based on at least the adjusted VIS image. Additional methods and systems are also provided.

### CROSS REFERENCE TO RELATED APPLICATIONS

This application is a continuation-in-part of International Application No. PCT/US2025/046807 filed Sep. 17, 2025 and entitled “IMAGE RECTIFICATION SYSTEMS AND METHODS,” which claims priority to and the benefit of U.S. Provisional Patent Application No. 63/698,542 filed Sep. 24, 2024 and entitled “IMAGE RECTIFICATION SYSTEMS AND METHODS,” all of which is incorporated herein by reference in its entirety.

This application also claims priority to and the benefit of U.S. Provisional Patent Application No. 63/740,629 filed Dec. 31, 2024 and entitled “LOW-LIGHT IMAGE ENHANCEMENT SYSTEMS AND METHODS,” which is incorporated herein by reference in its entirety.

### TECHNICAL FIELD

The present invention relates generally to imaging systems and, more particularly, to low-light enhancement and image rectification systems and methods.

### BACKGROUND

Visible spectrum cameras are used in a variety of imaging applications to capture color or monochrome images derived from visible light. Visible spectrum cameras are often used for daytime or other applications when there is sufficient ambient light or when image details are not obscured by smoke, fog, or other environmental conditions detrimentally affecting the visible spectrum.

Infrared cameras are used in a variety of imaging applications to capture infrared (e.g., thermal) emissions from objects as infrared images. Thermal, or infrared (IR), images of scenes are often useful for monitoring, inspection and/or maintenance purposes, and the like. Infrared cameras may be used for nighttime or other applications when ambient lighting is poor or when environmental conditions are otherwise non-conducive to visible spectrum imaging. Infrared cameras may also be used for applications in which additional non-visible-spectrum information about a scene is desired.

Imaging systems exist that use two or more separate imagers to capture two or more separate images or video streams of a target object or scene, which can be used to create a fusion image. For example, a multimodal imaging system (also referred to as a multispectral imaging system) that comprises at least two imaging modules configured to capture images in different spectra (e.g., visible light, infrared light, ultraviolet, and so on) is useful for analysis, inspection, or monitoring purposes, since a same object or scene can be captured in images of different spectra that can compared, combined, or otherwise processed for a better understanding of the target object or scene.

However, fusion images can often be difficult to interpret due to, for example, a lack of light, which may result in reduced resolution, lack of contrast between objects, and/or excess noise.

### SUMMARY

Techniques are disclosed for systems and methods for generating an enhanced fusion images based on lighting conditions and/or ambient light availability. A method is provided for generating an enhanced combined image in low lighting. The method includes receiving an image pair of a scene, the image pair comprising a visible light (VIS) image of the scene captured using a VIS imaging device and an infrared (IR) image of the scene captured using an IR imaging device; generating a combined image having one or more quality characteristics based on the image pair; adjusting a contrast of at least a portion of the VIS image based on the combined image; and generating an enhanced combined image based on the adjusted VIS image and the IR image.

In one or more embodiments, a method of low-light imaging enhancement is provided. The method includes receiving an image pair of a scene, the image pair comprising a visible light (VIS) image of the scene captured using a VIS imaging device and an infrared (IR) image of the scene captured using an IR imaging device; generating a combined image based on the image pair, wherein the combined image comprises one or more quality characteristics; adjusting one or more components of at least a portion of the VIS image based on the one or more quality characteristics of the combined image; and generating an enhanced combined image based on at least the adjusted VIS image.

In one or more embodiments, a system with low-light imaging enhancement is provided. The system includes a logic device configure to: receive an image pair of a scene, the image pair comprising a visible light (VIS) image of the scene captured using a VIS imaging device and an infrared (IR) image of the scene captured using an IR imaging device; generate a combined image based on the image pair, wherein the combined image comprises one or more quality characteristics; adjust one or more components of at least a portion of the VIS image based on the one or more quality characteristics of the combined image; and generate an enhanced combined image based on at least the adjusted VIS image.

The scope of the invention is defined by the claims, which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 illustrates a block diagram of an imaging system in accordance with an embodiment of the disclosure.

FIG. 2 illustrates a flow diagram showing a process for generating rectification parameters in accordance with an embodiment of the disclosure.

FIG. 3 illustrates a block diagram of an example imaging system in accordance with an embodiment of the disclosure.

FIG. 4 illustrates a diagram of calculating spatial deviation based on features of an image pair in accordance with an embodiment of the disclosure.

FIG. 5 illustrates a block diagram of a neural network in accordance with an embodiment of the disclosure.

FIG. 6 illustrates a regression analysis graph and corresponding code in accordance with an embodiment of the disclosure.

FIG. 7 illustrates a block diagram of an imaging system in accordance with an embodiment of the disclosure.

FIG. 8 illustrates a block diagram of a workflow of an imaging system in accordance with an embodiment of the disclosure.

FIG. 9 illustrates a flow chart showing a process of generating enhanced combined images in accordance with an embodiment of the disclosure.

Embodiments of the present invention and their advantages are best understood by referring to the detailed description that follows. It should be appreciated that like reference numerals are used to identify like elements illustrated in one or more of the figures.

### DETAILED DESCRIPTION

Embodiments of the present disclosure provide systems and methods for image rectification. Image rectification may be used during image fusion, where fusion includes merging information from a plurality of images (e.g., merging visible spectrum images and infrared images). In some embodiments, image rectification may be performed automatically and periodically by an imaging system to prevent and/or correct degradation of alignment parameters of the imaging system.

The basis of fusion is that a plurality of imaging devices (e.g., cameras) of an imaging system may be aligned and calibrated, for example, during a manufacturing process of the imaging devices so that information from a plurality of images captured by the imaging devices can be merged. Thus, proper alignment of the imaging devices is crucial for fusion. However, for various reasons, like external impact or unpredicted changes of hardware, the alignment may degrade over time. To combat such degradation, an imaging system may include hardware and/or software that provides automatic image rectification (e.g., registration). For example, the imaging system may include embedded software that, by analyzing images from each imaging device, can detect a current and/or expected alignment degradation (e.g., a constant misalignment), and also compensate for the degradation by providing rectification parameters and/or adjusting one or more hardware components of the imaging system based on the rectification parameters. In various embodiments, such a process may be run in the background, without user interaction and without external calibration equipment.

In some embodiments, alignment parameters (e.g., initial fusion parameters) are derived and saved during manufacturing of the imaging system. Periodically, while the imaging system is running, and preferably right after an event, such as, for example, focusing of one or more of the imaging devices of the imaging system (e.g., infrared optics), an image rectification process may be executed. The image rectification process may include capturing a plurality of images (e.g., infrared and visual images), applying alignment parameters to create a combined image based on the plurality of images, detecting features (e.g., objects, edges, corners, points, and so on) within each of the images of the plurality of images, either use all features or estimate which features are present in both an infrared image and a visual image, calculating a spatial deviation (e.g., misalignment, such as a constant misalignment that occurs over a specific duration of time, between the images and/or features of the images) based on the detected features, storing (e.g., save in a memory component or database) the spatial deviation and current operation conditions (e.g., camera settings such as focus, distance, and so on), generating rectification parameters (e.g., updated fusion parameters) based on at least the spatial deviation. The image rectification process may include adjusting the combined image based on the rectification parameters. In one or more embodiments, rectification parameters may be generated using, for example, decision support to detect if the misalignment is continuous (e.g., constant) over time and/or if the misalignment occurs with different camera settings (e.g., focus settings), and, in that case, to improve the initial alignment of the plurality of images. The image rectification process may include waiting for a subsequent event (e.g., new focus of one or more imaging devices of the plurality of imaging devices), and repeat the process.

In some embodiments, the imaging system may automatically/autonomously determine and/or set (e.g., image settings using one or more trained machine learning models). The machine learning model(s) may be a neural network (e.g., an artificial neural network, convolutional neural network, transformer-type neural network, and/or other neural network), a decision tree-based machine model, and/or other machine learning models. In some cases, the type of machine learning model trained and used may be dependent on the type of data. Image settings may include, by way of non-limiting examples, measurement functions (e.g., spots, boxes, lines, circles, polygons, polylines) such as temperature measurement functions, image parameters (e.g., emissivity, reflected temperature, distance, atmospheric temperature, external optics temperature, external optics transmissivity), palettes (e.g., color palette, grayscale palette), temperature alarms (e.g., type of alarm, threshold levels), fusion modes (e.g., thermal/visual only, blending, fusion, picture-in-picture (PIP)), fusion settings (e.g., alignment, PIP placement), level and span/gain control, zoom/cropping, equipment type classifications, fault classifications, recommended actions, text annotations/notes, and/or others.

In some embodiments, the present disclosure may further provide devices, systems, and methods for image enhancement. More specifically, devices, systems, and methods for low-light image enhancement are discussed herein. Low-light image enhancement may include processing of the fusion image and/or images of different spectra used to originally create the fusion image, where the fusion image may be altered to improve visualization and readability. In some embodiments, low-light image enhancement may include post-processing, such as enhancements and/or adjustments of components of an image after a main processing stage (e.g., pre-processing), where the components may include, for example, luminance, exposure, color, noise, sharpness, dimensions, orientation, brightness, intensity, contrast, or the like. In some embodiments, image enhancement may be performed automatically upon detection of a low-light image. In other embodiments, image enhancement may be performed in response to a user input.

The fusion image may be generated and/or created using one or more imaging devices, such as the plurality of imaging devices (e.g., cameras), of the system (e.g., imaging system). In various embodiments, a plurality of images captured by the one or more imaging devices may be combined to create a combined image, such as the fusion image, that includes components (e.g., image data) from each of the images used to create the combined image.

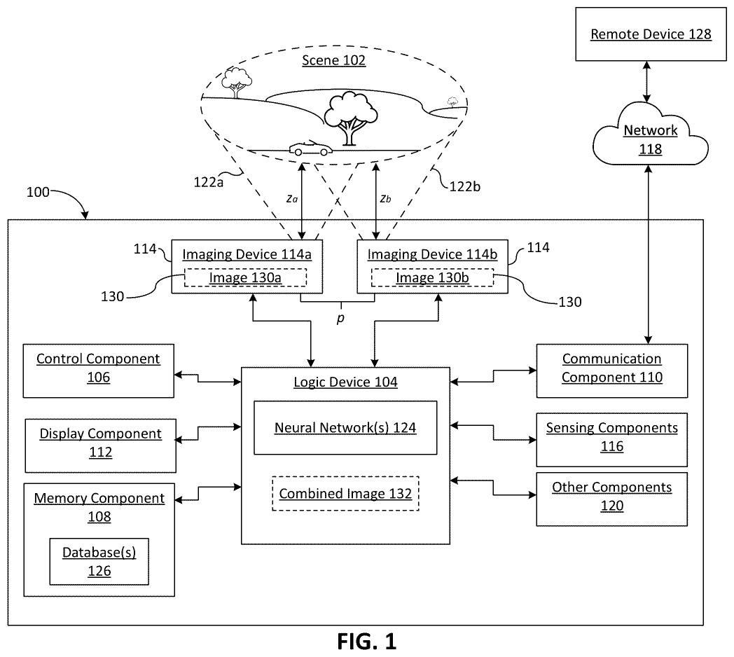

Referring now to the drawings, wherein the showings are for purposes of illustrating embodiments of the present disclosure and not for purposes of limiting the same, FIG. 1 shows a block diagram of an imaging system 100 in accordance with an embodiment of this disclosure. Imaging system 100 (also referred to herein as a “system”) may include various components, such as, but not limited to, a logic device 104, a memory component 108, a control component 106, a communication component 110, a display component 112, one or more imaging devices 114 (e.g., a plurality of imaging devices 114, such as first imaging device 114a and second imaging device 114b), sensing components 116, and/or other components 120. In one or more embodiments, imaging device 114 may include cameras configured to capture one or more images of a scene 102, as discussed further herein. Imaging system 100 may be configured to capture and/or process images in accordance with one or more embodiments of the disclosure. Imaging system 100 may represent any type of imaging system that detects one or more ranges (e.g., wavebands) of electromagnetic (EM) radiation and provides representative data (e.g., one or more still image frames or video image frames or streams). In one or more embodiments, imaging devices 114 may each be used to capture images of scene 102, such as visible and/or non-visible light images. For example, imaging devices 114 may each be used to capture and process two-dimensional (2D) visible light images (e.g., RGB frames). In another instance, imaging devices 114 may each be used to capture and process infrared (IR) images (e.g., thermal frames). In one or more embodiments, a position of imaging devices 114 relative to one or more objects of scene 102 may be provided by a user. In some embodiments, alignment parameters associate with imaging device 114 may be provided during user calibration and/or factory calibration.

Imaging system 100 may include a handheld camera system, a small form factor camera system provided as part of and/or an attachment to a personal electronic device such as a smartphone, a camera system mounted to a mobile structure, a camera system mounted to a fixed structure (e.g., building), or as another device. In one or more embodiments, imaging system 100 may include a portable device. The portable device may be handheld and/or may be incorporated, for example, into a vehicle or a non-mobile installation requiring images to be stored and/or displayed. The vehicle may be a land-based vehicle (e.g., automobile, truck), a naval-based vehicle, an aerial vehicle (e.g., unmanned aerial vehicle (UAV)), space vehicle, or generally any type of vehicle that may incorporate (e.g., installed within, mounted thereon, etc.) imaging system 100. In another example, imaging system 100 may be coupled to various types of fixed locations (e.g., a home security mount, a campsite or outdoors mount, or other location) via one or more types of mounts. In various embodiments, imaging device 114 may include an image capture component (e.g., an imager, an image sensor device, and so on), an image interface, and the like.

In one or more embodiments, imaging system 100 may include the plurality of imaging devices 114. By way of non-limiting examples, imaging devices 114 may be, may include, or may be a part of an infrared imaging device (e.g., an infrared or thermal camera), a visible-light imaging device (e.g., visible-light or visual camera), a tablet computer, a laptop, a personal digital assistant (PDA), a mobile device, a desktop computer, or other electronic device utilized to capture one or more images of a scene (e.g., scene 102). For example, and without limitation, imaging devices 114 may include first imaging device 114a and second imaging device 114b, where first imaging device 114a includes an infrared imaging device (e.g., infrared camera) configured to capture an infrared image of scene 102 and second imaging device 114b includes a visible-light imaging device (e.g., a visible-light camera) configured to capture a visible-light image (also referred to as a “visible spectrum image” or “visible image”) of scene 102. In various embodiments, each imaging device 114 may include a housing (e.g., a camera body) that at least partially encloses components of imaging device 114, such as to facilitate compactness and protection of each imaging device 114. In one or more embodiments, each imaging device 114a,b is configured to capture one or more images (e.g., frames) of scene 102 that is within a field of view (FOV) 122a,b of each imaging device 114a,b, respectively. In several embodiments, an object (e.g., target) may be within scene 102.

In one or more embodiments, each imaging device 114 may be positioned at a different location relative to other imaging devices of system 100, where each imaging device 114 may provide a different perspective of scene 102. Alignment parameters may be provided, for example, by a user of manufacturer to facilitate combining a plurality of images 130 (e.g., a first image 130a and a second image 130b) captured by the plurality of imaging deice 114 (e.g., first imaging device 114a and second imaging device 114b, respectively) based on the location (e.g., position and/or real-world location) of each imaging device relative to another imaging device of system 100 (e.g., physical location, orientation, angle, and/or the like of imaging device 114a relative to imaging device 114b). It will be appreciated that though system 100 is described as having two imaging devices herein, any number of imaging devices may be used without departing from the scope and spirit of the disclosure.

Each imaging device 114 may be configured to capture one or more images (e.g., image data) of a scene 102. In some embodiments, imaging devices 114 may include a focal plane array (FPA). In one or more embodiments, imaging devices 114 may include analog-to-digital converters to digitize an image captured by imaging device 114. In one or more embodiments, imaging devices 114 may include one or more visible light imaging devices (e.g., visible spectrum imaging devices), infrared imaging devices (e.g., thermal imaging devices), ultraviolet imaging devices, any combination thereof, and the like. For example, each imaging device 114 may include a two-dimensional (2D) camera, a three-dimensional (3D) camera, a four-dimensional (4D) scanner (e.g., a laser scanner configured to digitally capture the shape of an object and create point clouds of data), an infrared (IR) camera, an ultraviolet light camera, and so on.

One or more images 130 (e.g., image data) from imaging device 114 may be stored in memory component 108. In one or more embodiments, suitable image processing may be performed by logic device 104, which may be a software or firmware programmed computer processor or a hardwired processor. As previously mentioned herein, logic device 104 may represent any number of logic devices working independently and/or in concert. In some embodiments, logic devices 104 may be within imaging device 114. In some embodiments, one or more of such logic devices may be remote relative to imaging devices 114 and/or system 100 and are configured to wired and/or wirelessly communicate with imaging devices 114 and/or system 100 over a computer network (e.g., a network 118), such as the Internet, using communication component 110. Communication component 110 may provide wired and/or wireless connection to circuits, devices, and/or components of system 100. In some embodiments, communication component 110 may not be included in system 100 (e.g., is absent). For example, memory component 108 may include a plug-in module.

In various embodiments, imaging system 100 may include a logic device 104. Logic device 104 may be communicatively connected to any other components of imaging system 100. For example, logic device 104 may be communicatively connected to the plurality of imaging devices 114. Logic device 104 may be implemented as any appropriate logic device, such as, for example, a computing device, controller, processor, single-core processor, multi-core processor, control circuit, microprocessor, programmable logic device (PLD) configured to perform processing operations, processing device, digital signal processing (DSP) device, system on a chip (SOC), application specific integrated circuit (ASIC), field programmable gate array (FPGA), central processing unit (CPU), a graphics processing unit (GPU), a digital signal processing (DSP) device, neural processing unit (NPU), memory storage device, memory reader, and/or any other appropriate combinations of processing devices and/or memory to execute instructions to perform appropriate operations (e.g., logic device 104 may include a memory providing instructions configuring a processor to execute any of the processes described in this disclosure), such as, for example, software instructions implementing a control loop for controlling various operations of imaging system 100. Logic device 104 may be configured to execute software instructions to perform various operations discussed herein for embodiments of the disclosure. Such software instructions may also implement methods for processing images, processing sensor signals, determining sensor information, providing user feedback (e.g., through user interface), querying devices for operational or conditional parameters, selecting operational parameters for devices, or performing any of the various operations described herein (e.g., operations performed by logic devices of various devices of system 100). Logic device 104 may be configured to interface and communicate with the various other components (e.g., components 106, 108, 110, 112, 116, 118, 120, 128, and so on) of imaging system 100 to perform such operations. For example, logic device 104 may be configured to process captured image data (e.g., one or more images and/or or videos) received from imaging devices 114, store the image data in memory component 108, and/or retrieve stored image data from memory component 108. In one aspect, logic device 104 may be configured to perform various system control operations (e.g., to control communications and operations of various components of imaging system 100) and other image processing operations (e.g., video analytics, data conversion, data transformation, data compression, and the like).

Logic device 104 may include, be included in, and/or communicate with any component of system 100. In some embodiments, logic device 104 may include a single logic device. In other embodiments, logic device 104 may include a plurality of logic devices operating in parallel, in concert, in series, redundantly, and/or or in any other manner appropriate for operating system 100. In various embodiments, logic device 104 may distribute tasks and/or processes across a plurality of logic devices. In one or more embodiments, logic device 104 may be configured to perform any process, step, and/or sequence of steps described herein in any order and with any degree of repetition (e.g., iteratively). In various embodiments, logic device 104 may include a plurality of logic devices in a single unit integrated into imaging devices 114 or remote (e.g., remote device 128). In other embodiments, logic device 104 may include a plurality of logic devices partly integrated into imaging device 114 and/or remote. For example, logic device 104 may include a single logic device or a plurality of logic devices in a first location, and a second logic device or cluster of logic devices in a second location. In various embodiments, logic device 104 may be implemented as a memory, wherein logic device may include one or more logic devices dedicated to data storage.

In some embodiments, logic device 104 may be configured to receive images from each imaging device 114 (e.g., an imaging module), process the images, store the original and/or processed images in memory component 108, and/or retrieve stored images from memory component 108. In various aspects, logic device 104 may be configured to receive images from imaging devices 114 through wired and/or wireless communication using, for example, communication component 110. In one or more embodiments, logic device 104 may be configured to process images. For example, logic device 104 may use machine-learning modules and/or neural networks 124 (e.g., convolutional neural network (CNN)) to process one or more images provided by imaging devices 114. For example, logic device 104 may use artificial neural networks (ANNs), such as fusion ANN 302, detection ANN 304, deviation ANN 312, rectification ANN 318, and the like, as described further herein below.

Imaging system 100 may include a memory component 108. In one or more embodiments, memory component 108 may include one or more memory devices configured to store data and information, including image data and information. Memory component 108 may include one or more various types of memory devices including, but not limited to, volatile and non-volatile memory devices, such as random access memory (RAM), dynamic RAM (DRAM), static RAM (SRAM), non-volatile random-access memory (NVRAM), read-only memory (ROM), programmable read-only memory (PROM), erasable programmable read-only memory (EPROM), electrically-erasable programmable read-only memory (EEPROM), flash memory, hard disk drive, and/or other types of memory. As discussed above, logic device 104 may be configured to execute software instructions stored in memory component 108 so as to perform method and process steps and/or operations. Logic device 104 and/or imaging devices 114 may be configured to store in memory component 108 images, or image data (e.g., digital image data), captured by imaging devices 114. In some embodiments, memory component 108 may store various infrared images, visible-light images, ultraviolet images, combined images (e.g., infrared images blended with visible-light images), image settings, alignment parameters, rectification parameters, user input, sensor data, and/or any other data or information discussed herein.

In some embodiments, memory component 108 (e.g., a memory, such as a hard drive, a compact disk, a digital video disk, or a flash memory) may store software instructions and/or configuration data which can be executed or accessed by a computer (e.g., logic device 104 or processor-based system) to perform various methods and operations, such as methods and operations associated with processing image data. In one aspect, the machine-readable medium may be portable and/or located separate from imaging system 100, with the stored software instructions and/or data provided to imaging system 100 by coupling (e.g., communicatively connecting) the machine-readable medium to imaging system 100 and/or by imaging system 100 downloading (e.g., via a wired link and/or a wireless link) from the machine-readable medium. It should be appreciated that various modules and/or components may be integrated in software and/or hardware as part of the logic device 104, with code (e.g., software or configuration data) for the modules and/or components stored, for example, in memory component 108.

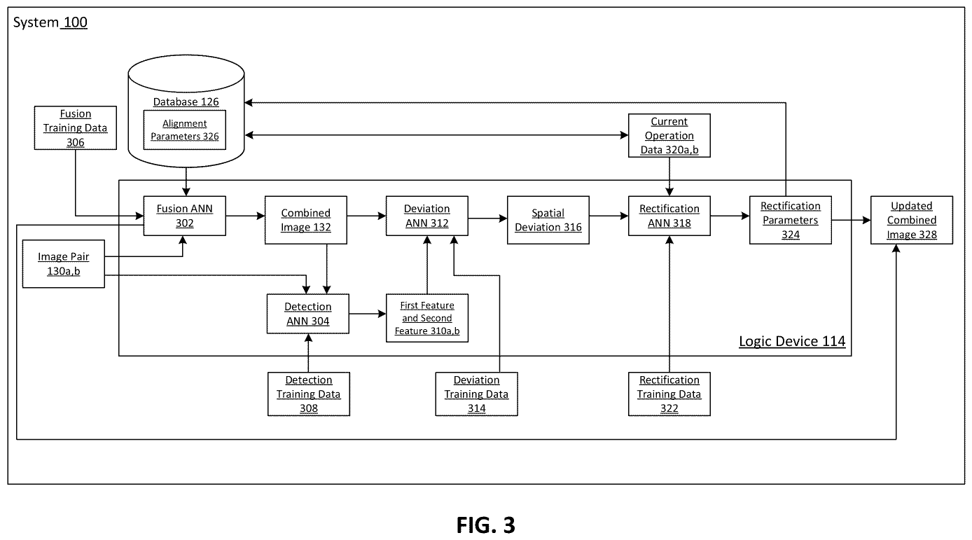

In various embodiments, memory component 108 may be adapted to store databases, such as database 126 or other data. Other data may include any data or information (e.g., instructions) used by system 100 (e.g., logic device 104) to perform any processes, steps, and/or sequences of steps described herein. For example, in some embodiments, other data may include training data (also referred to herein as “training sets” or “training data sets”) used for generating and/or training ANNs 302, 302, 312, and 318, shown in FIG. 3. In some embodiments, other data may include alignment parameters 326. For example, alignment parameters may include one or more parallax values between each of the plurality of imaging devices 114, expected point errors, and so on. Alignment parameters may include alignment parameters provided by a user and/or manufacturer. In some embodiments, alignment parameters may include historical alignment parameters so that alignment parameters of previous iterations of system 100 may be stored and recalled from memory component 108 for using to adjust a combined image based on the alignment parameters and rectification parameters and/or for use a training data.

Imaging devices 114 may each include a video and/or still camera configured to capture and process images and/or videos of scene 102. In this regard, the image capture components of each imaging device 114 may be configured to capture images (e.g., still and/or video images) of scene 102 in a particular spectrum or modality. In various embodiments, image capture component may include an image detector circuit (e.g., a visible-light detector circuit, a thermal infrared detector circuit, and so on) and a readout circuit (e.g., a readout integrated circuit (ROIC)). For example, and without limitation, the image capture component may include an IR imaging sensor (e.g., IR imaging sensor array) configured to detect IR radiation in the near, middle, and/or far IR spectrum and provide IR images (e.g., IR image data or signal) representative of the IR radiation from scene 102. For example, the image detector circuit may capture (e.g., detect and/or sense) IR radiation with wavelengths in the range from around 700 nm to around 2 mm, or portion thereof. In some aspects, the image detector circuit may be sensitive to (e.g., better detect) SWIR radiation, mid-wave IR (MWIR) radiation (e.g., EM radiation with wavelength of 2 μm to 5 μm), and/or long-wave IR (LWIR) radiation (e.g., EM radiation with wavelength of 7 μm to 14 μm), or any desired IR wavelengths (e.g., generally in the 0.7 μm to 14 μm range). In other aspects, the image detector circuit may capture radiation from one or more other wavebands of the EM spectrum, such as visible light, ultraviolet light, and so forth.

Image detector circuit may capture one or more images (e.g., image data, such as infrared or visible-light image data) associated with scene 102. An image may be referred to as a frame or an image frame. To capture an image (e.g., a detector output image), the image detector circuit may detect image data of scene 102 (e.g., in the form of EM radiation) received through an aperture of the imaging device 114 and generate pixel values of the image based on scene 102. In one or more embodiments, the image detector circuit may include an array of detectors (also referred to herein as an “array of pixels”) that can detect radiation of a certain waveband, convert the detected radiation into electrical signals (e.g., voltages, currents, etc.), and generate the pixel values based on the electrical signals. Each detector in the array may capture a respective portion of the image data and generate a pixel value based on the respective portion captured by the detector. The pixel value generated by the detector may be referred to as an output of the detector. By way of non-limiting examples, each detector may include a photodetector, such as an avalanche photodiode, an infrared photodetector, a quantum well infrared photodetector, a microbolometer, or other detector capable of converting EM radiation to a pixel value.

The detector output image may be, or may be considered, a data structure that includes pixels and is a representation of the image data associated with scene 102, with each pixel having a pixel value that represents EM radiation emitted or reflected from a portion of scene 102 and received by a detector that generates the pixel value. Based on context, a pixel may refer to a detector of the image detector circuit that generates an associated pixel value or a pixel (e.g., pixel location, pixel coordinate) of the detector output image formed from the generated pixel values. In one example, the detector output image may be an infrared image (e.g., thermal infrared image). For a thermal infrared image (e.g., also referred to as a thermal image), each pixel value of the thermal infrared image may represent a temperature of a corresponding portion of scene 102. In another example, the detector output image may be a visible-light image.

In an aspect, the pixel values generated by the image detector circuit may be represented in terms of digital count values generated based on the electrical signals obtained from converting the detected radiation. For example, in a case that the image detector circuit includes or is otherwise coupled to an analog-to-digital (ADC) circuit, the ADC circuit may generate digital count values based on the electrical signals. For an ADC circuit that can represent an electrical signal using 14 bits, the digital count value may range from 0 to 16,383. In such cases, the pixel value of the detector may be the digital count value output from the ADC circuit. In other cases (e.g., in cases without an ADC circuit), the pixel value may be analog in nature with a value that is, or is indicative of, the value of the electrical signal. As an example, for infrared imaging, a larger amount of IR radiation being incident on and detected by the image detector circuit (e.g., an IR image detector circuit) is associated with higher digital count values and higher temperatures.

The readout circuit may be utilized as an interface between the image detector circuit that detects the image data and logic device 104 that processes the detected image data as read out by the readout circuit, with communication of data from the readout circuit to the logic device 104 facilitated by the image interface. An image capturing frame rate may refer to the rate (e.g., detector output images per second) at which images are detected/output in a sequence by the image detector circuit and provided to the logic device 104 by the readout circuit. The readout circuit may read out the pixel values generated by the image detector circuit in accordance with an integration time (e.g., also referred to as an integration period).

In various embodiments, a combination of the image detector circuit and the readout circuit may be, may include, or may together provide the FPA. In some aspects, the image detector circuit may be a thermal image detector circuit that includes an array of microbolometers, and the combination of the image detector circuit and the readout circuit may be referred to as a microbolometer FPA. In some cases, the array of microbolometers may be arranged in rows and columns. The microbolometers may detect IR radiation and generate pixel values based on the detected IR radiation. For example, in some cases, the microbolometers may be thermal IR detectors that detect IR radiation in the form of heat energy and generate pixel values based on the amount of heat energy detected. The microbolometers may absorb incident IR radiation and produce a corresponding change in temperature in the microbolometers. The change in temperature is associated with a corresponding change in resistance of the microbolometers. With each microbolometer functioning as a pixel, a two-dimensional image or picture representation of the incident IR radiation can be generated by translating the changes in resistance of each microbolometer into a time-multiplexed electrical signal. The translation may be performed by the ROIC. The microbolometer FPA may include IR detecting materials such as amorphous silicon (a-Si), vanadium oxide (VOx), a combination thereof, and/or other detecting material(s). In an aspect, for a microbolometer FPA, the integration time may be, or may be indicative of, a time interval during which the microbolometers are biased. In this case, a longer integration time may be associated with higher gain of the IR signal, but not more IR radiation being collected. The IR radiation may be collected in the form of heat energy by the microbolometers.

In some embodiments, image devices 114 may include image capture components having one or more optical components and/or one or more filters. The optical component(s) may include one or more windows, lenses, mirrors, beamsplitters, beam couplers, and/or other components to direct and/or focus radiation to the image detector circuit. For example, in a non-limiting example, an image capturing component may include an IR imaging sensor having an FPA of detectors responsive to IR radiation including near infrared (NIR), SWIR, MWIR, LWIR, and/or very-long wave IR (VLWIR) radiation. In some other embodiments, alternatively or in addition, the image capture component may include a complementary metal oxide semiconductor (CMOS) sensor or a charge-coupled device (CCD) sensor that can be found in any consumer camera (e.g., visible light camera).

The images, or the digital image data corresponding to the images, received by logic device 104 may be associated with respective image dimensions (also referred to as “pixel dimensions”). An image dimension, or pixel dimension, generally refers to the number of pixels in an image, which may be expressed, for example, in width multiplied by height for two-dimensional images or otherwise appropriate for relevant dimension or shape of the image. Thus, images having a native resolution, may be resized to a smaller size (e.g., having smaller pixel dimensions) in order to, for example, reduce the cost of processing and analyzing the images. Filters (e.g., a non-uniformity estimate) may be generated based on an analysis of the resized images. The filters may then be resized to the native resolution and dimensions of the images, before being applied to the images.

In various embodiments, display component 112 includes, in one embodiment, an image display device (e.g., a liquid crystal display (LCD)) or various other types of generally known video displays or monitors. Logic device 104 may be configured to display image data and information on display component 112. The logic device 104 may be configured to retrieve image data and information from memory component 108 and display any retrieved image data and information on display component 112. Display component 112 may include display circuitry, which may be utilized by logic device 104 to display image data and information. Display component 112 may be adapted to receive image data and information directly from the image capture component, logic device 104, and/or image interface, or the image data and information may be transferred from memory component 108 via the logic device 104. In some aspects, control component 106 may be implemented as part of display component 112. For example, a touchscreen of the imaging device 105 may provide both control component 106 (e.g., for receiving user input via taps and/or other gestures) and display component 112 of the imaging device 114.

In one or more embodiments of the present disclosure, imaging system 100 may include sensing components 116. In various embodiments, sensing components 116 include, in one embodiment, one or more sensors of various types, depending on the application or implementation requirements, as would be understood by one skilled in the art. Sensors of sensing components 116 provide data and/or information to at least logic device 104. In one aspect, logic device 104 may be configured to communicate with sensing components 116. Sensing components may include a global positioning system (GPS), gyroscope, accelerometer, Light Detection and Ranging (LIDAR), laser scanner, radio detection and ranging (RADAR), range finder, ultrasonic imaging device, and/or the like. In some embodiments, information provided by other sensing components may be used to provide operation data to logic device 104 and/or for storing on memory component 108, as discussed further herein below. In a non-limiting example, the gyroscope may be configured to provide a current orientation of one or more of the plurality of imaging devices 114. Using the current orientation of one or more of the imaging devices parallax, pointing errors, and so on may be determined. In other embodiments, system 100 may be configured to automatically adjust one or more aspects and/or image settings of an imaging device based on rectification parameters and orientation data. In another non-limiting example, LIDAR may be configured to provide a distance between one or more imaging devices of the plurality of imaging devices 114 and an object within scene 102. Sensing components 116 may represent conventional sensors as generally known by one skilled in the art for monitoring various conditions (e.g., environmental conditions) that may have an effect (e.g., on the image appearance) on the image data provided by the imaging devices and/or provide past or current operation data, as discussed further below in this disclosure.

In some implementations, sensing components 116 (e.g., one or more sensors) may include devices that relay information to logic device 104 via wired and/or wireless communication. For example, sensing component 116 may be adapted to receive information from a satellite, through a local broadcast (e.g., radio frequency (RF)) transmission, through a mobile or cellular network and/or through information beacons in an infrastructure (e.g., a transportation or highway information beacon infrastructure), or various other wired and/or wireless techniques. In some embodiments, logic device 104 can use the information (e.g., sensing data) retrieved from sensing components 116 to modify a configuration of the image capture component (e.g., adjusting a light sensitivity level, adjusting a direction or angle of the imaging devices, adjusting an aperture, and/or the like).

In various embodiments, system 100 may include other components. In some embodiments, other components 120 may include interface components. For example, other components may include a control component, such as a user input and/or an interface device. A user interface may include, but is not limited to, a rotatable knob (e.g., potentiometer), push buttons, slide bar, keyboard, and/or other devices, that is adapted to generate a user input control signal. Logic device 104 may be configured to sense control input signals from a user via the control component and respond to any sensed control input signals received therefrom. Logic device 104 may be configured to interpret such a control input signal as a value, as generally understood by one skilled in the art. In one embodiment, the control component may include a control unit (e.g., a wired or wireless handheld control unit) having push buttons adapted to interface with a user and receive user input control values. In one implementation, the push buttons and/or other input mechanisms of the control unit may be used to control various functions of the imaging device 114, such as calibration initiation and/or related control, shutter control, autofocus, menu enable and selection, field of view, brightness, contrast, noise filtering, image enhancement, and/or various other features. In some cases, the control component may be used to provide user input (e.g., for adjusting image settings).

In some embodiments, various components of imaging system 100 may be distributed and in communication with one another over network 118, as previously mentioned herein. In this regard, each imaging device 114 may include a network interface configured to facilitate wired and/or wireless communication among various components of imaging system 100 over network 118. In such embodiments, components may also be replicated if desired for particular applications of imaging system 100. That is, components configured for same or similar operations may be distributed over a network. Further, all or part of any one of the various components may be implemented using appropriate components of the remote device 128 (e.g., a conventional digital video recorder (DVR), a computer configured for image processing, a smartphone, a tablet, a host device, a server, and/or other device) in communication with various components of imaging system 100 via the network interface over network 118, if desired. Thus, for example, all or part of logic device 104, all or part of the memory component 108, and/or all of part of display component 112 may be implemented or replicated at remote device 128. In some embodiments, imaging system 100 may not include imaging sensors (e.g., image devices), but instead receive images, or image data, from imaging sensors located separately and remotely from logic device 104 and/or other components of imaging system 100. It will be appreciated that many other combinations of distributed implementations of imaging system 100 are possible without departing from the scope and spirit of the disclosure.

In one or more embodiments, remote device 128 may be referred to as a host device or user device. The host device may communicate with imaging devices 114 via a network interface and network 118. For example, imaging devices 114 may communicatively communicate with remote device 128. The network interface and network 118 may collectively provide appropriate interfaces, ports, connectors, switches, antennas, circuitry, and/or generally any other components of imaging devices 114 and remote device 128 to facilitate communication between imaging devices 114 and remote device 128. Communication interfaces may include an Ethernet interface (e.g., Ethernet GigE interface, Ethernet GigE Vision interface), a universal serial bus (USB) interface, other wired interface, a cellular interface, a Wi-Fi interface, other wireless interface, or generally any interface to allow communication of data between imaging devices 114 and the remote device 128.

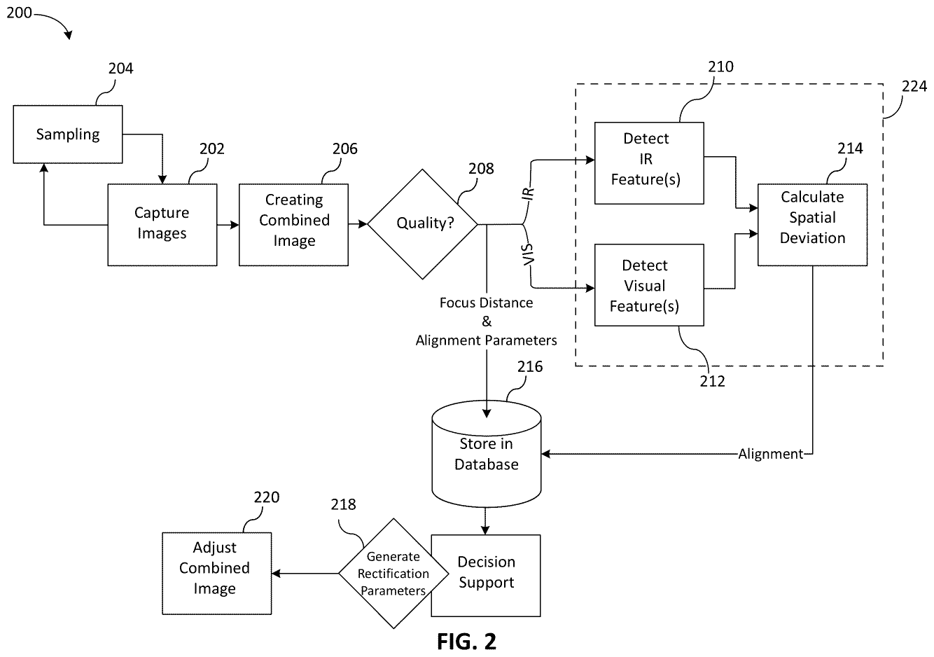

FIG. 2 illustrates a flowchart for a process 200 for generating rectification parameters in accordance with an embodiment of the present disclosure. For explanatory purposes, process 200 is primarily described within this disclosure with reference to system 100 and its associated arrangement of components as described in FIGS. 1 and 3-6. However, process 200 is not limited to such implementations. Any step, sub-step, sub-process, or block of process 200 may be performed in an order or arrangement different from the embodiments illustrated in FIG. 2; some may be omitted, others may be added, and some may be performed simultaneously as appropriate.

As shown in block 202, process 200 may include capturing a plurality of images 130 using a plurality of imaging devices, such as, for example, capturing one or more infrared images using an infrared imaging device (e.g., imaging device 114a) and one or more visual images using a visible imaging device (e.g., imaging device 114b). In one or more embodiments, plurality of images 130 may be captured based on one or more events. For example, an event may include activation of autofocus of one or more of the imaging devices 114, focusing by a user manipulation of one or more of the imaging device 114 by a user manipulation, actuation of one or more of the imaging device 114 by a user manipulation (e.g., the user actuating a button, using a gesture, or the user using a verbal instruction or voice command to actuate the imaging devices and capture an image), and/or the like.

As shown in block 204, in one or more embodiments, imaging system 100 may be configured to initiate process 200 discretely (e.g., in the background) during operation of imaging system 100. For example, process 200 may be initiated by an event. The event may include, for example, a predetermined time (e.g., image captured every n minutes), an environmental condition (e.g., detection of object of a specific temperature), an operation setting of one or more of imaging devices 114 (e.g., one or more of the imaging devices is focused, autofocus occurs, an image is captured based on a user actuation or automation of imaging device, and so on), an/or the like. For example, and without limitation, samples may be taken from a plurality of images when one or more of imaging devices 114 capture an image 130 or when a user activates autofocus of one or more of the imaging devices. In various embodiments, process 200 includes determining the rate of sampling, which may be based on the alignment parameters (e.g., fusion parameters).

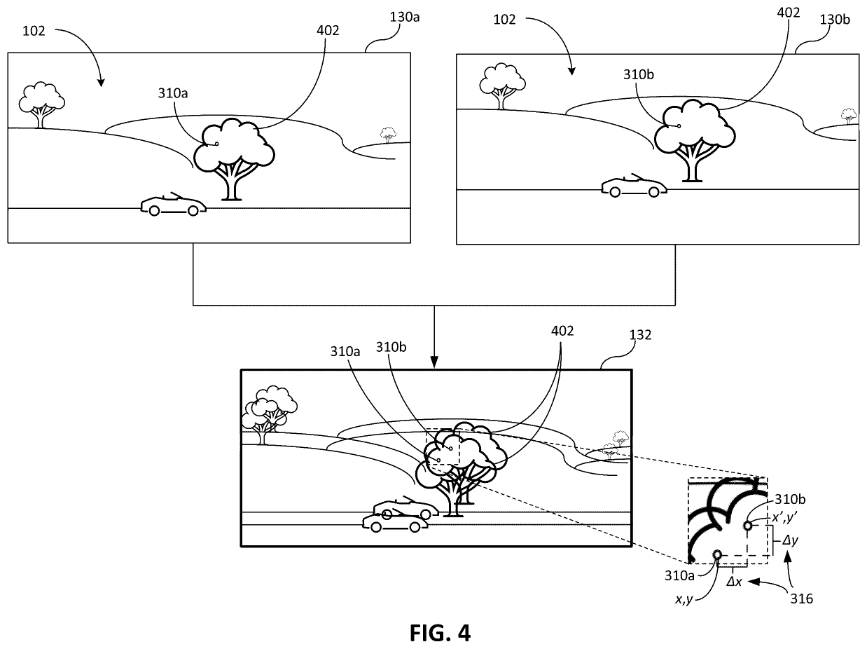

As shown in block 206, process 200 may include creating combined image 132 (also referred to herein as a “fusion image”). Creating combined image 132 may include combining the plurality of images 130 captured by the plurality of imaging devices 114. To create the combined image 132, logic device 104 may apply alignment parameters (e.g., fusion parameters) to align the plurality of images 130 (e.g., infrared image and visual image) relative to each other. For example, logic device 104 may be configured to produce combined image 132 of scene 102 based on image pair 130a,b and the alignment parameters, as discussed further in FIG. 4. For example, in some embodiments, an infrared imaging device may be configured to produce one or more infrared images that can be combined with visible spectrum images captured at substantially the same time to produce a high resolution, high contrast, and/or targeted contrast combined image of scene 102.

In some embodiments, logic device 104 may be configured to create combined image 132 and/or updated combined image 328 using an ANN, such as fusion ANN 302 of FIG. 3, as discussed further below herein.

In some embodiments, logic device 104 may determine and/or receive a focus distance (e.g., distance to target) of each imaging device of the plurality of imaging devices, and thus each focus distance associated with each image 130. Logic device 104 may be configured to use depth extraction (e.g., separate extraction of focus distance). For example, logic device 104 may be configured to extract the pixels of regions in focus and merge the pixels of transition regions.

In some embodiments, infrared images and visible spectrum images may be combined using triple fusion processing operations, for example, which may include selectable aspects of non-uniformity correction (NUC) processing, true color processing, high contrast processing, and/or the like. In such embodiments, the selectable aspects of the various processing operations may be determined by user input, threshold values, control parameters, default parameters, and/or other operating parameters of system 100. For example, a user may select and/or refine each individual relative contribution of a non-uniformity correction, true color processed images, and/or high contrast processed images, to combined images (e.g., plurality of images 130) displayed to the user on, for example, display component 112. The combined images may include aspects of all three processing operations that can be adjusted in real-time programmatically and/or by a user utilizing a suitable user interface.

In some embodiments, various image analytics and processing may be performed according to a specific mode and/or context associated with an application, a scene, a condition of a scene, an imaging system configuration, a user input, an operating parameter (e.g., image setting) of system 100, and/or other logistical concerns. For example, in the overall context of maritime imaging, such modes may include a night docking mode, a man overboard mode, a night cruising mode, a day cruising mode, a hazy conditions mode, a shoreline mode, a night-time display mode, a blending mode, a visible-only mode, an infrared-only mode, and/or other modes.

In some embodiments, pre-combining operations may include applying a high pass filter, applying a low pass filter, applying a non-linear low pass filter (e.g., a median filter), adjusting dynamic range (e.g., through a combination of histogram equalization and/or linear scaling), scaling dynamic range (e.g., by applying a gain and/or an offset), and adding image data derived from these operations to each other to form processed images. For example, a pre-combining operation may include extracting details and background portions from a radiometric component of an infrared image using a high pass spatial filter, performing histogram equalization and scaling on the dynamic range of the background portion, scaling the dynamic range of the details portion, adding the adjusted background and details portions to form a processed infrared image, and then linearly mapping the dynamic range of the processed infrared image to the dynamic range of display 112 of system 100. In one embodiment, the radiometric component of the infrared image may be a luminance component of the infrared image. In other embodiments, such pre-combining operations may be performed on one or more components of the visible spectrum images.

As with other image processing operations, pre-combining operations may be applied in a manner so as to retain a radiometric and/or color space calibration of the original received images. Resulting processed images may be stored temporarily (e.g., in memory component 108) and/or may be further processed according to process 200. Any of the techniques described herein, or described in other applications or patents referenced herein, may be applied to any of the various thermal devices, non-thermal devices, and uses described herein.

In various embodiments, alignment parameters may include parameters for substantially aligning the plurality of images 130 (e.g., first image 130a and second image 130b). In some embodiments, alignment parameters may include parameters for approximately aligning each overlapping pair of images (e.g., translation, rotation, scaling, skewing, various other transformations, and the like). In one embodiment, alignment parameters are embodied in a two-dimensional array with the alignment parameters for every possible pair of images. For example, for n images, alignment parameters may be contained in an array of N×N elements, such that alignment parameter {i,j} gives the alignment parameters (translation, rotation, and scaling) for aligning image j with image i. In some embodiments, alignment parameters may include lens distortion parameters, which may include estimating lens distortion parameters for each imaging device. In some embodiments, alignment parameters may include normalization parameters.

In various embodiments, alignment parameters may be provided by a manufacturer. In other embodiments, alignment parameters may be provided as a software update of system 100 provided by, for example, a remote and/or host device (e.g., remote device 128).

In various embodiments, logic device 104 may be configured to create combined image 132 by combining an image pair (e.g., image pair 130a,b). In some embodiments, image pair 130a,b may be overlapped together using a set of alignment and/or registration parameters, which allows correct alignment (e.g., with an error up to 2% of FOV in some implementations) of any pair of overlapping images based on the initial manufacturing settings of system 100 (e.g., prior to degradation of system 100). In some embodiments, image pair 130a,b may include images taken simultaneous by imaging devices 114,b respectively, of scene 102 within their respective FOVs 122a,b, at distances zₐ and z_{b} from scene 102 (e.g., an object within scene 102), as shown in FIG. 1. In some embodiments, distances zₐ and z_{b} are the same value (e.g., z). In other embodiments, distance zₐ and z_{b} are different values.

As shown in block 208, process 200 may include determining a quality of each of the plurality of images 130 and/or the combined image using, for example, logic device 104. For example, logic device 104 may determine if combined image 132 should be further processed (if process 200 should be continued using combined image 132) based on the determined quality of combined image 132. For example, logic device 104 may check the focus distance, image blur, and/or the like of combined image 132 to determine if the quality of the combined image is sufficient for use to generate rectification parameters. In various embodiments, determining a quality of each of images 130 and/or combined image 132 may include comparing the first and second image and/or the combined image to one or more quality characteristics. Quality characteristics may include a qualitative and/or quantitative predetermined standard and/or tolerance for quality of an image. Quality characteristics may be provided by a user (e.g., manual user input) and/or the manufacturer. Quality characteristics may include a tolerance associated with focus distance, image blur, and/or the like of the image.

As shown in blocks 210 and 212, process 200 may include detecting features (e.g., feature points) in the plurality of images (e.g., first image 130a and second image 130b). For example, logic device 104 may be configured to detect features of an infrared image and visual image of an image pair.

In some embodiments, detecting features of each image of the plurality of images may include extracting features from each image and comparing (e.g., matching) each feature in each image of the plurality of images. Features may include points, edges, corners, and the like. For example, features may include a characteristic of an object within scene 102 and thus images 130, as discussed further below herein. In a non-limiting example, a plurality of features may be detected in the infrared and visual images. In other embodiments, one feature may be detected in the infrared and visual images. In some embodiments, feature may include the same object, or portion of the object, in each image of the plurality of images. For example, feature may include the same point, edge, corner, and so on, of the same identified object in each image. For example, feature may include the same point on a hand of a person within the plurality of images. In some embodiments, logic device 104 may be configured to compare features in each image of the plurality of images and derive a current and/or eventual spatial deviation (e.g., misalignment) of the images based on the difference in location of the feature within each image. For example, a location (e.g., position) of a first feature within the first image may be compared to a location (e.g., position) of the second feature within the second image. The spatial deviation may be derived using, for example, linear equations, minimizing a cost function, and the like.

In one or more embodiments, captured images may be received by logic device 104 and stored in memory component 108. As previously mentioned, logic device 104 may extract from each of the captured images 130 a subset of pixel values of scene 102 corresponding to a feature (e.g., detected object, corner, edge, point, and so on). The trained inference network (e.g., a trained image classification neural network) may classify the detected object and store the result in memory component 108, a database (e.g., object database), and/or other memory storage in accordance with system preferences. In some embodiments, logic device 104 may send images or detected objects over network 118 (e.g., the Internet or the cloud) to a server system (e.g., remote device 128) for remote image classification. In various embodiments, the inference network is a trained image classification system that may be implemented in a real-time environment.

In one or more embodiments, a neural network may be used to detect one or more features of the image pair. In some embodiments, an ANN may include a special type of a deep network that can take in an input image and extract one or more features of the input image by, for example, performing a mathematical operation called convolution multiple times. Initial layers of the network may extract low level features (e.g., detecting edges, shapes, and/or the like) and subsequent layers are responsible for extracting high level features and/or finally classifying objects.

The CNN (e.g., detection ANN 304 of FIG. 3) may be trained using a labeled training dataset that include images captured from an infrared, visible light, or other type of device that corresponds to input devices and/or data input to the object detection and classification system. In some embodiments, the training dataset includes one or more synthetically generated or modified images. The training dataset may also include other input data (e.g., the output of another trained neural network or sensor data) that may be available to the system. For example, the training process may be expanded to incorporate radar data, sonar data, GPS data, and/or other data. The training may include a forward pass of the training dataset through the CNN, including feature extraction through the plurality of convolution layers and pooling layers, followed by image classification in a plurality of fully connected hidden layers and an output layer. Next, a backward pass through the CNN may be used to update the weighting parameters for nodes of the CNN to adjust for errors produced in the forward pass (e.g., misclassified objects). In various embodiments, other types of neural networks and other training processes may be used in accordance with the present disclosure. The trained CNN may then be implemented in a runtime environment to classify objects in image regions of interest. The runtime environment may include one or more implementations of the systems and methods disclosed herein.

In various embodiments, feature detection may include processes such as, for example, bilateral filtering, edge extraction, feature extraction (e.g., using SIFT descriptors, LIOP descriptors, and/or the like), feature matching, removing of false matches (e.g., using RANSAC, manually set thresholds, and/or the like), adjusting focus settings, and so on.

As shown in block 214, a spatial deviation may be calculated based on the first and second feature extraction. In one or more embodiments, calculating the spatial deviation of image pair 130a,b may include deriving a misalignment between image pair 130a,b. In some embodiments, process 200 may include learning-based registration, as shown in block 224. Calculating spatial deviation may include comparing a first feature of first image 130a to a second feature of second image 130b, where the first feature and the second feature are the same feature (e.g., point, edge, corner, object, etc.). Comparing the first and second feature may include determining displacement in one or more directions (e.g., horizontal and/or vertical translations) between the first feature and the second feature, as discussed further in FIG. 4. In some embodiments, spatial deviation may be determined using a CNN (e.g., deviation ANN 312), as discussed further in FIG. 3.

As shown in block 216, process 200 may include storing spatial deviation in a memory and/or database. For example, spatial deviation may be saved in memory component 108 (e.g., database 126 of memory component 108, as shown in FIGS. 1 and 3). Moreover, operation data associated with spatial deviation may be stored in database 126. Operation data may include aspects (e.g., settings) associated with each imaging device of the plurality of imaging devices 114 during the capturing of one or more images used to create combined image 132. For example, operation data may include, but is not limited to, a distance between each of the imaging devices and the scene or a target within the scene or distance of focus (e.g., z), focus setting, lighting setting (e.g., white balance, contrast, and so on), a time at which an image is captured or a time between the capturing of one or more images, and so on. For example, process 200 may include storing the spatial deviation and corresponding first operation data of the first imaging device 114a (e.g., first focus setting) and second operation data of the second imaging device 114b (e.g., second focus setting) in memory component 108 and/or database 126. In some embodiments, process 200 may include the first operation data and the second operation data including a distance of focus (e.g., distance to target) of first imaging device 114a and second imaging device 114b, respectively. In some embodiments, alignment parameters may be stored in memory component 108 and retrieved by logic device 104 from memory component 108 (e.g., database 126). In various embodiments, the current misalignment of combined image 132 may be stored in memory component 108 (e.g., database 126).

As shown in block 218, process 200 may include generating rectification parameters (e.g., updated fusion parameters). In some embodiments, rectification parameters may include a value associated with a pointing error between the first imaging device and the second imaging device, a value associated with a parallax error between the first imaging device and the second imaging device, and/or the like. In some embodiments, logic device 104 may be configured to generate rectification parameters based on at least spatial deviation. In other embodiments, logic device 104 may be configured to generate rectification parameters based on spatial deviation and alignment parameters. In various embodiments, generating rectification parameters may include generating rectification parameters using decision support. For example, decision support may include a neural network (i.e. convolutional neural network) configured to determine one or more characteristics of the spatial deviation, as discussed further in FIG. 3. The CNN may determine, based on at least the spatial deviation, whether the alignment parameters (e.g., initial fusion parameters) need to be adjusted in order to properly combine the plurality of captured images from imaging devices 114a,b. In various embodiments, process 200 may include determining if the rectification parameters (e.g., updated fusion parameters) should be implemented based on at least the calculated spatial deviation. For example, and without limitation, logic device 104 may use a CNN to determine whether rectification parameters should be implemented (e.g., whether the initial alignment parameters should be updated and/or altered to compensate for any detected misalignments between the plurality of images).

In one or more embodiments, process 200 includes determining whether the rectification parameters should be used to adjust the combined image. For example, the decision support may compare the spatial deviation to a predetermined threshold to determine whether the alignment parameters should be updated using the rectification parameters. The predetermined threshold may include a quantitative value and/or range of values. When the value associated with the predetermined threshold hold is exceeded by the value associated with the misalignment then the rectification parameters may be used to adjust the alignment of the combined image.

In one or more embodiments, rectification parameters may be compared to the product information (e.g., product specification) provided by, for example, the manufacturer. In some embodiments, the manufacturer may update the product information and transmit the updated product information to system 100 over, for example, network 118.

In one or more embodiments, process 200 may include comparing a plurality of spatial deviations over a predetermined duration of time to determine whether to alter alignment parameters 326 using rectification parameters 324. In some embodiments, the plurality of spatial deviations may each be stored in database 126, as described in block 216. In some embodiments, a plurality of spatial deviations may be calculated at different times and/or may be associated with different image pairs. Logic device 104 may be configured to compare the plurality of spatial deviations to each other to determine whether rectification parameters should be generated and/or combined image should be updated. For example, a first spatial deviation, second spatial deviation, up to an nth spatial deviation may be calculated from a first image pair, a second image pair, up to an nth image pair, respectively, over a specific duration of time such as, for example, several hours, to determine a trend and/or correlation between the plurality of spatial deviations. If the plurality of spatial deviations, continuously (e.g., consistently) occur over the several hours, then logic device 104 may be configured to generate rectification parameters and/or update alignment parameters. As understood by one of ordinary skill in the art, the duration of time may include any desirable and/or applicable duration of time dependent on a desired application(s). For example, spatial deviations may be calculated every few seconds, minutes, hours, days, and/or the like. In some embodiments, spatial deviations may be calculated every time an image pair is captured. In other embodiments, spatial deviations may be calculated at a specific and/or predetermined amount of time. In various embodiments, the spatial deviations and their respective, associated operation data of imaging devices (e.g., operation data and/or updated operation data) may each be stored in memory component 108 and/or databases.

As shown in block 220, process 220 may include adjusting combined image 132. In some embodiments, adjusting the combined image may include adjusting the combined image 132 by applying the rectification parameters to combined image 132 to create an updated combined image 328 (e.g., adjusted combined image). In other embodiments, adjusting the combined image may include temporarily and/or permanently altering the alignment parameters based on the rectification parameters, which are then used to combine the plurality of images 130 to create the updated combined image. In some embodiments, adjusting the combined image may include permanently altering the alignment parameters based on rectification parameters to create second alignment parameters.

In some embodiments, process 200 may further include comparing the latest image pair (e.g., frames) or a sequence of image pairs (e.g., sequence of frames over a specific amount of time). For example, the image pair 130a,b may include a first image pair and the spatial deviation may include a first spatial deviation. Process 200 may further include receiving a second image pair of the scene, where the second image pair includes a third image from first imaging device 114a and a fourth image from second imaging device 114b. Process 200 may include creating, using the alignment parameters, a second combined image based on the second image pair. Process 200 may include identifying the first feature of the object in the third image and the second feature of the object in the fourth image and determining a second spatial deviation based on at least the first feature and the second feature. In some embodiments, the first feature and the second feature may include the same point, line, edge, and/or component of a target or scene. For example, first feature and second feature may both include the same portion of a target and/or real-world location (e.g., real-world coordinates) within a scene. In other embodiments, the first feature, second feature, third feature, and fourth feature may include the same point, line, edge, and/or component of a target and/or scene. In various embodiments, process 200 may include storing the second spatial deviation and corresponding first operation data of the first imaging device and the second operation data of the second imaging device.

Any number of image pairs may be captured and compared to determine if a misalignment is constant over time. For example, logic device 104 may determine that a misalignment is occurring over a specific duration of time among a plurality of image pairs. For example, logic device 104 may determine that the misalignment is constant over time despite the image settings (e.g., operation data) of imaging devices 114a,b. If the misalignment continuously occurs over time, then logic device 104 may be configured to use the rectification parameters to alter the combined image (e.g., updated fusion parameters and/or create an updated combined image).

In some embodiments, the misalignment may be caused by a mechanical degradation, where one or more components of system 100 has been jarred or moved so that the plurality of images no longer align using alignment parameters 326 (e.g., the current or initial set of alignment parameters provided by the manufacturer and/or a user during calibration (e.g., in-the-field calibration)). If after multiple samplings the misalignment is determined to be constant over time, then logic device 104 may generate rectification parameters. For example, if a spatial deviation is consistently calculated for each image pair received (e.g., despite the corresponding operation data, such as focus settings, of the imaging devices), then logic device 104 may generate rectification parameters to correct the identified degradation of system 100.

In one or more embodiments, process 200 includes showing information associated with generating the rectification parameters on display 112. For example, process 200 may include providing a visual representation of the first image, the second image, the combined image, and/or the updated combined image. For example, process 200 may include displaying the first image and the second image of the image pair simultaneously (e.g., overlayed) on display component 112 for viewing by a user. In another example, the images may be displayed on a display component system 100 and/or a display component of a remote device (e.g., of remote system 128, a smartphone, and so on). The first image, the second image, the combined image, and/or the updated combined image may be displayed side-by-side, picture-in-picture, vertically stacked, overlayed, and/or in any other configurations.

Providing the visual representation may include visual annotations, such as highlighting, flagging, or otherwise noting differences between the first and second image and/or the combined image and/or the updated combined image. The user may use the interface of system 100 to navigate display 112 and/or add or remove visual annotations. In some embodiments, the differences between the first and second image (e.g., spatial deviation) may be detected using a processor (e.g., logic device 104), such as via a neural network running a machine learning algorithm or other artificial intelligence, as discussed further herein. Visual annotations may further include boxing or otherwise isolating the detected difference (e.g., spatial deviation).

FIG. 3 illustrates a block diagram of a second embodiment of system 100 in accordance with various embodiments of the present disclosure. In one or more embodiments of the present disclosure, logic device 104 may be configured to receive a plurality of images of scene 102 from imaging devices 114. For example, in one or more embodiments, logic device 104 may be configured to receive an image pair 130 of scene 102 provided (e.g., transmitted) by imaging devices 114 to logic device 104. In some embodiments, image pair 130 may include a first image 130a from first imaging device 114a and a second image 130b from second imaging device 114b.

In one or more embodiments, images 130a,b may be captured for sampling, as previously discussed in FIG. 2. Sampling may occur when a particular event, such as autofocus of imaging devices 114a,b, shutter actuation (e.g., when an image is captured), focusing of imaging devices 114a,b by a user, and the like occurs. For example, a sample may be taken in response to an autofocus of one or more imaging devices 114. In some embodiments, sampling may include how often system 100 uses a captured image to calculate a spatial deviation and/or generate rectification parameters. In some embodiments, sampling may include a sampling time, which may include a frequency at which samples are collected over a predetermined duration of time. In some embodiments, the sampling time may include periodic sampling. In other embodiments, sampling time may include continuous sampling. For example, sampling may occur several times a day. In one or more embodiments, sampling may be triggered (e.g., initiated) in response to an event, such as an actuation of one or more imaging devices of system 100, as previously mentioned herein.

In one or more embodiments, logic device 104 may be configured to create a combined image 132 based on image pair 130a,b and alignment parameters 326 as previously described in FIGS. 1 and 2. In various embodiments, a convolutional neural network may be configured to combine image pair 130a,b. In some embodiments, a convolutional network such as fusion artificial neural network (ANN) 302 may be configured to combine image pair 130. For example, first image 130a and second image 130b may be combined based on alignment parameters 326. Alignment parameters 326 may include parameters provided during manufacturing, as previously discussed herein. Alignment parameters 326 may be stored in memory component 108 of system 100, such as, for example, in a database 126 of memory component 108.

In various embodiments, alignment parameters 326 may be stored on memory component 108. For example, alignment parameters may be stored in an alignment database. In one or more embodiments, alignment parameters may include initial rectification parameters. Alignment parameters may include information used by system 100 (e.g., logic device 104) to align a plurality of images (e.g., first and second image 130a and 130b) captured by imaging devices 114 (e.g., imaging devices 114a and 114b, respectively) to create combined image 132. Alignment parameters may be derived and saved (e.g., stored in memory component 108) during manufacturing of system 100 (e.g., imaging device 114). To maintain accurate alignment of the plurality of images, periodically, while system 100 is running, and preferably right after focusing of the imaging device 114, such as the focusing of the infrared imaging device and/or the visible imaging device, a loop may be run to ensure the plurality of images are properly aligned when combined to create combined image 132.

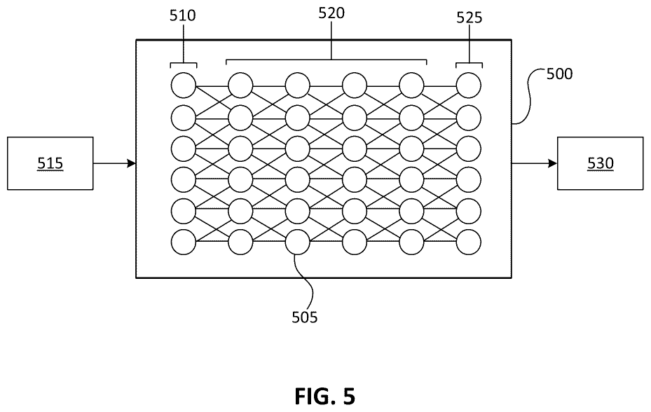

In one or more embodiments, logic device 104 may be configured to identify a first feature 310a in the first image 130a and a second feature 310b in the second image 130b. In some embodiments, a convolutional neural network of logic device 104 and/or of a remote device, such as remote device 128, may be used to identify first and second features 310a,b. For example, and without limitation, detection ANN 304 may be configured to detect first and second features 310a,b of first and second images 130a,b, respectively. Detection ANN 304 may be trained using detection training data 308, which may be, for example, received from a database or inputted by a user. In some embodiments, identifying the first and second features 310a,b may include determining real-world coordinates with scene 102 associated with first and second features 310a,b. In one or more embodiments, detection ANN 304 may be trained as a function of a detection training set, where the detection training set correlates example image inputs with example feature outputs, as discussed further in FIG. 5.

In one or more embodiments, logic device 104 may be configured to calculate a spatial deviation 316 based on first and second features 310a,b of first and second images 130a,b. In various embodiments, logic device 104 may be configured to calculate spatial deviation 316 by comparing first and second features 310a,b, as previously discussed herein. For example, in some embodiments, logic device 104 may determine a translation between first and second features 310a,b (e.g., a difference between a first location (e.g., first position x,y) of first features 310a and between a second location (e.g., second position x′,y′) of second features 310b), as discussed further in FIG. 4.

In one or more embodiments, logic device 104 may include a CNN configured to calculate spatial deviation 316. For example, deviation ANN 312 may be configured to calculate spatial deviation 316 based on first and second features 310, which is discussed further herein below in FIGS. 4-6. In various embodiments, determining spatial deviation 316 may include comparing a translation between first feature 310a and second feature 310b. In one or more embodiments, deviation ANN 312 may be trained as a function of a deviation training set, where the deviation training set correlates example features inputs with example spatial deviation outputs, as discussed further in FIG. 5.

In one or more embodiments, logic device 104 may be configured to store spatial deviation 316 and current operation data 320 in memory component 108 and/or database 126. Current operation data 320a,b may include operation data associated with each imaging device when each corresponding image (e.g., first image 130a and second image 130b) is captured. For example, current operation data may include first operation data 320a of first imaging device 114a and second operation data 320b of second imaging device 114b. In some embodiments, first operation data 320a and second operation data 320b may include a distance of focus (e.g., distance to target, z) of first imaging device 114a and second imaging device 114b, respectively. In some embodiments, first operation data and second operation data are the same. In other embodiments, first operation data and second operation data are different.

In one or more embodiments, image pair 130a,b may include a first image pair 130a,b and the spatial deviation may include a first spatial deviation. In some embodiments, logic device 104 is configured to receive a second image pair of scene 102. Second image pair may include a third image from first imaging device 114a and a fourth image from second imaging device 114b. Logic device 104 may then be configured to create, using alignment parameters 326, a second combined image based on the second image pair. Logic device 104 may further be configured to identify the first feature in the third image and the second feature in the fourth image. In some embodiments, the first feature of the third image and the second feature of the fourth image may be the same features and the first feature from the first image and the second image. In other embodiments, the first feature of the third image and the second feature of the fourth image may be different features from the first feature from the first image and the second image. Logic device 104 may be configured to determine a second spatial deviation based on at least the first feature and the second feature of the third image and the fourth image, respectively. In one or more embodiments, logic device 104 may be configured to store the second spatial deviation and respective operation data of the first imaging device and the second imaging device. For example, logic device 104 may be configured to store the second spatial deviation and corresponding updated first operation data of the first imaging device and updated second operation data of the second imaging device, as previously discussed in FIG. 2.

In one or more embodiments, logic device 104 may be configured to generate rectification parameters 324 based on at least spatial deviation 316. For example, in various embodiments, logic device 104 may include a CNN configured to generate rectification parameters 324. For example, and without limitation, logic device 104 may include rectification ANN 318, which may be configured to generate rectification parameters 324 based on spatial deviation 316. In one or more embodiments, rectification ANN 318 may be trained as a function of a rectification training set 322, where the rectification training set correlates example spatial deviation inputs with example rectification parameter outputs, as discussed further in FIG. 5.

In various embodiments, spatial deviation 316 may be compared to a predetermined threshold to determine if rectification parameters 324 should be calculated and/or to determine if combined image 132 should be adjusted based on rectification parameters 324, as previously discussed in this disclosure. For example, using a threshold ANN, logic device 104 may be configured to compare spatial deviation 316 to predetermined threshold, and thus determine if rectification parameters 324 should be implemented to create updated combined image 328.

In one or more embodiments, logic device 104 may be configured to adjust combined image 132 based on rectification parameters 324 (e.g., create an updated combined image 328). For example, and without limitation, logic device 104 may be configured to create an updated combined image 328 based on combined image 132, rectification parameters 324, and/or alignment parameters 326. In some embodiments, logic device 104 may be configured to adjust combined image 132 using fusion ANN 302 and based on rectification parameters 324.

In various embodiments, logic device 104 may be configured to create a new combined image (e.g., updated combined image 328) based on image pair 130a,b and rectification parameters 324. In some embodiments, logic device 104 may be configured to create updated combined image 328 using fusion 302 based on image pair 130a,b and rectification parameters 324, as previously mentioned.

In some embodiments, logic device 104 may be configured to adjust combined image 132 by altering alignment parameters 326 based on rectification parameters 324 to create updated alignment parameters (e.g., altered alignment parameters), where logic device 104 may be configured to create updated combined image 328 based on such updated alignment parameters. For example, logic device 104 may be configured to adjust combined image 132 based on images 130a,b, alignment parameters 326, and rectification parameters 324. In some embodiments, alignment parameters 326 may be temporarily altered and/or updated using rectification parameters 324 and then applied to the current image pair 130a,b to create updated combined image 328. Additionally and/or alternatively, alignment parameters 326 may be permanently altered using and/or replaced by rectification parameters (e.g., alignment parameters 326 may be overwritten based on rectification parameters 324) so that updated alignment parameters are used on the current and subsequent image pairs to create subsequent combined images until new rectification parameters (e.g., subsequent rectification parameters) are generated using logic device 104.

In some embodiments, logic device 104 may be configured to adjust combined image 132 by deforming first image 130a and/or second image 130b based on rectification parameters 324 to align the first image 103a and the second image 130b. For example, second image 130b may be deformed (e.g., skewed, warped, rotated, translated, and/or the like) so that all detected features of second image 130b align with all corresponding detected features of first image 130a.

In one or more embodiments, database 126 may include one or more alignment parameters that each may be associated with alignment of first image and second image to create combined image 132. Furthermore, database 126 may include current operation data. Alignment database may be generated, updated, and/or altered by a manufacturer and/or by a user (e.g., by user input). In one or more embodiments, training data (e.g., fusion training data, detection training data, deviation training data, rectification training data, and so on) may include inputs and outputs from databases (e.g., database 126 or respective data bases such as a fusion database, detection database, deviation database, rectification database, and so on), resources, and/or manual user inputs (e.g., data entered by a user) used for generating a machine-learning model and/or neural network. For example, training data may include training inputs and correlated training outputs that may be received by logic device 104 to generate and/or train a neural network, such as the ANNs described herein. In several embodiments, correlations may indicate causative or predictive links between data (e.g., inputs and outputs) and may include modeled relationships (e.g., mathematical relationships). For example, a neural network, such as rectification ANN 318, may use correlations to determine an output, such as rectification parameters, from an input, such as spatial deviation. In some embodiments, training data may include historical training data, where historical training data includes previously received inputs and corresponding determined outputs (e.g., historical inputs and outputs that have been fed back into the system). In some embodiments, the neural network may iteratively be updated using previously used inputs and determined outputs.

FIG. 4 illustrates calculating spatial deviation 316 in accordance with various embodiments of the present disclosure. As previously mentioned, logic device 104 may be configured to receive image pair 130a,b of a scene 102 (shown in FIG. 1). Image pair 130a,b may include first image 130a from first imaging device 114a, and second image 130b from second imaging device 114b. In some embodiments, logic device 104 may be configured to create combined image 132 using a neural network or other methods described in this disclosure. Though calculating spatial deviation is shown as calculating a single spatial deviation associated with a feature point, as understood by one of ordinary skill in the art, calculating spatial deviation may include calculating a plurality of spatial deviations associated with a plurality of features and/or the same feature. For example, calculating spatial deviation may include calculating three spatial deviations of the image pair, including a first spatial deviation, a second spatial deviation, and a third spatial deviation, where each spatial deviation is associated with a different feature within the image pair. In various embodiments, a feature may be associated with the same object and/or different objects relative to other features. For example, in some embodiments, one or more features may be related to the same object in the scene (e.g., sky, land, a mobile structure, a gas, a person, water, and so on) relative to the other features. In another example, one or more features may be related to a different object in the scene relative to the other features. Calculating a plurality of spatial deviations for an image pair may aid in the determination of rectification parameters, where rectification parameters may include values associated with translation, rotation, warping, and/or the like of the first or second image.

In one or more embodiments, logic device 104 may be configured to identify features 310a,b of each image 130a,b of the plurality of images 130 captured by imaging devices 114a,b. For example, logic device 104 may be configured to identify a first feature 310a in first image 130a and a second feature 310b in second image 130b. In some embodiments, each feature may include a point, edge, corner, and/or the like of an object 402 of image pair 130a,b. In various embodiments, comparing first and second features 310a,b relative to each other may include determining vertical and/or horizontal displacement between the first feature 310a and second feature 310b.

In one or more embodiments, logic device 104 may be configured to calculate spatial deviation 316 based on first and second features 310a,b of first and second images 130a,b. In various embodiments, logic device 104 may be configured to calculate spatial deviation 316 by comparing first and second features 310a,b, as previously discussed herein. For example, in some embodiments, logic device 104 may determine a translation (e.g., horizontal and/or vertical displacement) between first and second features 310a,b. Determining a translation between first and second features 310a,b may include determining a difference (Δx, Δy) between a first location (x,y) of first feature 310a and a second location (x′,y′) of second feature 310b within combined image 132. If the difference (Δx, Δy) exceeds the predetermined threshold (e.g., tolerance), then logic device 104 may be configured to adjust combined image 132 based on rectification parameters 324, creating updated combined image 328.

Various aspects of the present disclosure may be implemented to use and train neural networks, decision tree-based machine models, and/or other machine learning models. Such models may be used to analyze captured image data, identify features, calculate spatial deviations, and/or generate rectification parameters and may be adjusted/updated responsive to user input and/or feedback.

As an example of a machine learning model used and updated in accordance with embodiments herein, FIG. 5 illustrates a block diagram of a neural network 500 (e.g., an artificial neural network) in accordance with one or more embodiments of the present disclosure. Neural network may include any neural network discussed in this disclosure, such as fusion ANN 302, detection ANN 304, deviation ANN 312, and/or rectification ANN 318. In an aspect, the neural network 500 may be a CNN. In an embodiment, the neural network 500 may be implemented by logic device 104. Neural network 500 may be used to process image data to determine image settings. In some cases, the neural network 500 may detect/identify features (e.g., of a scene and/or of an object within the scene). An object, or object of interest, may include, but is not limited to landscape (e.g., tree, bush, body of water, and/or the like), a person, an animal, a mobile structure, a gas (e.g., gas leak detection), and the like. A feature of an object may include information associated with characteristics of the potential targets (e.g., location of the potential targets within the image, geolocation of object within the real-world, temperature of object, classification of the object, and so on), and determine the image settings based at least on such detections. Such characteristics may be shown on the display for a user to view.

As shown, neural network 500 may include various nodes 505 (e.g., neurons) arranged in multiple layers including an input layer 510 receiving one or more inputs 515, hidden layers 520, and an output layer 525 providing one or more outputs 530. The input(s) 515 may collectively provide a training dataset for use in training the neural network 500. Although particular numbers of nodes 505 and layers 510, 520, and 525 are shown, any desired number of such features may be provided in various embodiments. The training dataset may include images, image settings of the imaging devices that are associated with the captured images (e.g., operation data), user input (or lack thereof), rectification parameters, alignment parameters, and any other inputs discussed within this disclosure. In some cases, the images may be formed of registered visible-light and infrared pairs. In some embodiments, the neural network 500 may be trained to determine one or more image settings and provide the image setting(s) as the output(s) 530. In other embodiments, the outputs may include a combined image, spatial deviation, rectification parameters or any other outputs discussed in this disclosure.

In some embodiments, neural network 500 operates as a multi-layer classification tree using a set of non-linear transformations between the various layers 510, 520, and/or 525 to extract features and/or information from images (e.g., thermal images and/or visible images) by an imager (e.g., the imaging devices 114). For example, neural network 500 may be trained on large amounts of data. Such data may include image data (e.g., thermal images, visible-light images, combined images generated from thermal images and visible-light images), geoposition data, feature data (e.g., data associated with the position and/or location of features, alone or relative to each other, within one or more images), camera orientation data, temperature data of internal camera components, focus distance data (e.g., data associated with the distance between imaging devices and an object in the scene), and/or other data. This procedure may be iteratively repeated until neural network 500 has trained on enough data such that neural network 500 can perform predictions of its own.

Neural network 500 may be used to perform feature detection, as previously discussed in this disclosure in FIGS. 1-4, and additional characteristic detection on various images (e.g., thermal images, visible light images, and so on) captured by system 100 and provide to input(s) 515 of the neural network 500. Neural network 500 may be trained by providing image data (e.g., thermal images, visible-light images, combined images generated from thermal images and visible-light images) and/or other data of known targets (e.g., circuit boards, fuse boxes) with known characteristics (e.g., images and related information regarding the characteristics may be stored in a database associated with training neural networks) to the input(s) 515.

In some embodiments, detected features, operation data (e.g., information associated with image settings of the imaging devices when the images are captured), and/or other data obtained by analyzing images using neural network 500 may be presented (e.g., displayed) to a user, such as to provide the user an opportunity to review the data and provide user input to adjust the data as appropriate. The user input may be analyzed and fed back (e.g., along with the image settings that caused the user input) to update a training dataset used to train the neural network 500. In this regard, the user input may be provided in a backward pass through the neural network 500 to update neural network parameters based on the user input. In some aspects, the backward pass may include back propagation and gradient descent. In some cases, the presence of user input with regard to a given image setting output by the neural network 500 may indicate that the user has determined the image setting to be in error (e.g., not correct to the user). In some cases, the lack of user input with regard to a given image setting may indicate that the user has determined the image setting to not be in error (e.g., sufficiently correct for the user). Adjustment of the training dataset (e.g., by removing prior training data, adding new training data, and/or otherwise adjusting existing training data) may allow for improved accuracy (e.g., on-the-fly). In some aspects, by adjusting the training dataset to improve accuracy, the user may avoid costly delays in implementing accurate feature classifications, image setting determinations, and so forth.

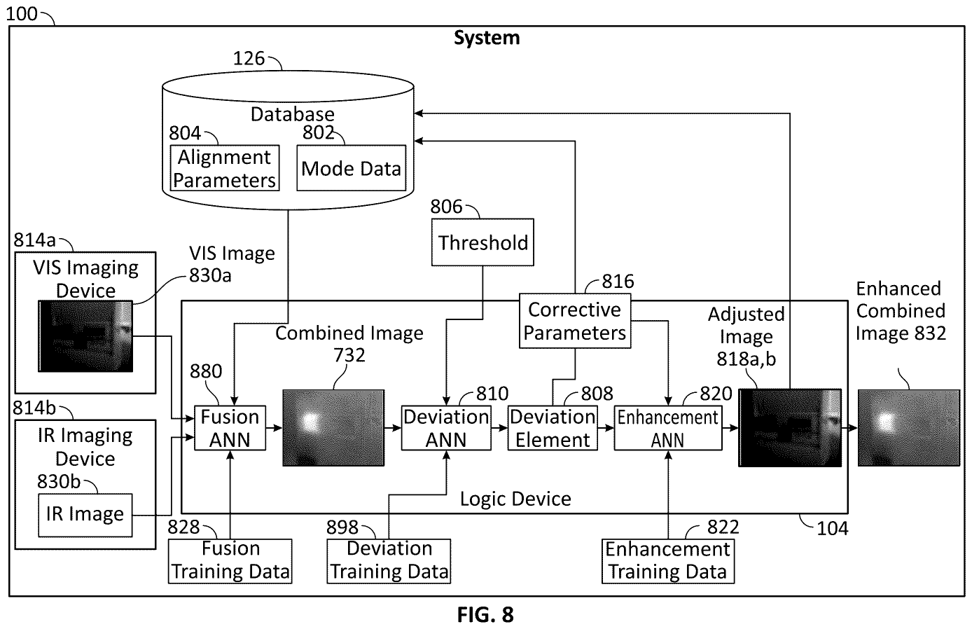

In other embodiments, neural network may include fusion ANN 880 (e.g., fusion ANN 320), deviation ANN 810, and/or enhancement ANN 820, as shown in FIG. 8. In an aspect, the neural network 500 may be a CNN. In an embodiment, the neural network 500 may be implemented by logic device 104. Neural network 500 may be used to process image data to determine image settings. In some cases, the neural network 500 may detect/identify features (e.g., of a scene and/or of an object within the scene). An object, or object of interest, may include, but is not limited to landscape (e.g., tree, bush, body of water, and/or the like), a person, an animal, a mobile structure, a gas (e.g., gas leak detection), and the like. A feature of an object may include information associated with characteristics of the potential targets (e.g., location of the potential targets within the image, geolocation of object within the real-world, temperature of object, classification of the object, and so on), and determine the image settings based at least on such detections. Such characteristics may be shown on the display for a user to view.

In some embodiments, neural network 500 operates as a multi-layer classification tree using a set of non-linear transformations between the various layers 510, 520, and/or 525 to extract features and/or information from images (e.g., thermal images and/or visible images) by an imager (e.g., imaging devices 114). For example, neural network 500 may be trained on large amounts of data. Such data may include image data (e.g., thermal images, visible-light images, combined images generated from thermal images and visible-light images), geoposition data, feature data (e.g., data associated with the position and/or location of features, alone or relative to each other, within one or more images), camera orientation data, temperature data of internal camera components, focus distance data (e.g., data associated with the distance between imaging devices and an object in the scene), and/or other data. This procedure may be iteratively repeated until neural network 500 has trained on enough data such that neural network 500 can perform predictions of its own.

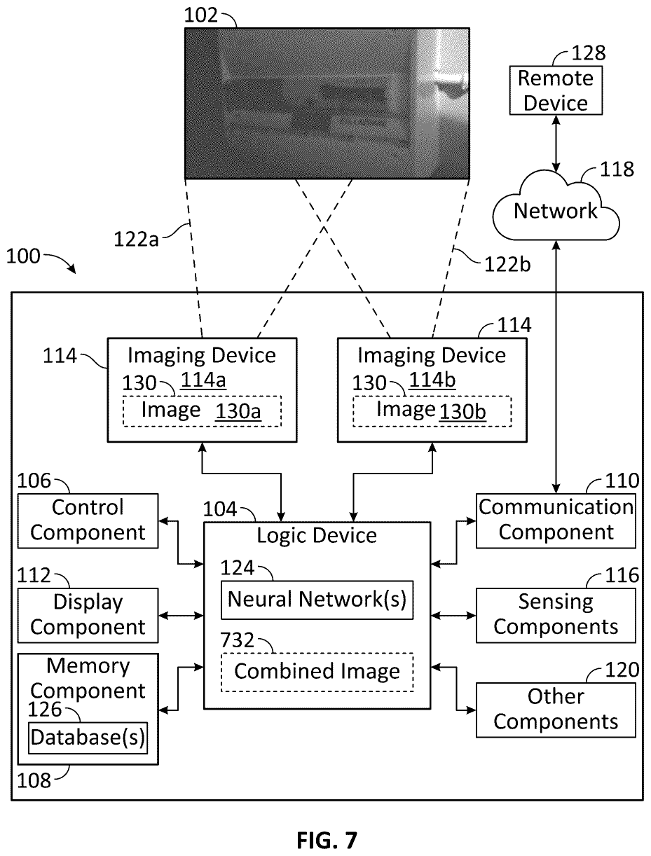

Neural network 500 may be trained by providing image data (e.g., thermal images, visible-light images, combined images generated from thermal images and visible-light images) and/or other data of known targets (e.g., circuit boards, fuse boxes) with known characteristics (e.g., images and related information regarding the characteristics may be stored in a database associated with training neural networks) to the input(s) 515, as discussed further in in FIGS. 7-9.

In other embodiments, neural network 500 may be trained by providing image data (e.g., thermal images, visible-light images, combined images generated from thermal images and visible-light images) and/or other data of known targets (e.g., circuit boards, fuse boxes) with known characteristics (e.g., images and related information regarding the characteristics may be stored in a database associated with training neural networks) to the input(s) 515, as discussed further in FIGS. 7-9.

In some embodiments, blending parameters, corrective parameters, deviation elements, detected features, operation data (e.g., information associated with image settings of the imaging devices when the images are captured), and/or other data obtained by analyzing images using neural network 500 may be presented (e.g., displayed) to a user, such as to provide the user an opportunity to review the data and provide user input to adjust the data as appropriate. The user input may be analyzed and fed back to update a training dataset used to train the neural network 500. In this regard, the user input may be provided in a backward pass through the neural network 500 to update neural network parameters based on the user input. In some aspects, the backward pass may include back propagation and gradient descent. In some cases, the presence of user input with regard to a given image setting output by the neural network 500 may indicate that the user has determined settings, conditions, and/or parameters to be in error (e.g., not correct to the user). In some cases, the lack of user input with regard to given settings, conditions, and/or parameters may indicate that the user has determined them to not be in error (e.g., sufficiently correct for the user). Adjustment of the training dataset (e.g., by removing prior training data, adding new training data, and/or otherwise adjusting existing training data) may allow for improved accuracy (e.g., on-the-fly). In some aspects, by adjusting the training dataset to improve accuracy, the user may avoid costly delays in implementing accurate feature classifications, image setting determinations, and so forth.

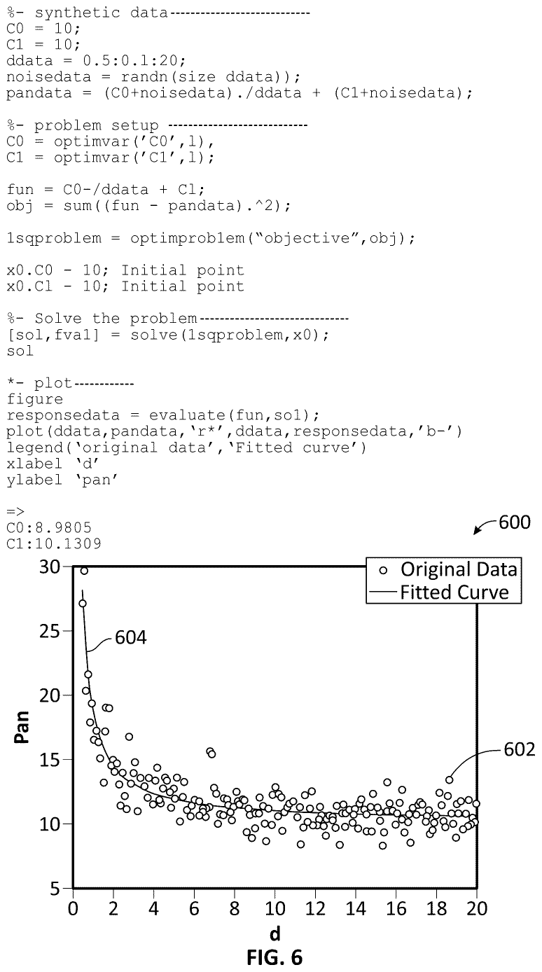

FIG. 6 shows a regression analysis graph 600 and corresponding code, using example data, in accordance with an embodiment of the present disclosure. In various embodiments, a regression analysis may be performed on saved data (e.g., current or previous alignment parameters, spatial deviations, rectification parameters, and/or the like). In one or more embodiments, the rectification parameters may be used to update and/or alter the alignment parameters. In other embodiments, the rectification parameters may be rewritten over alignment parameters. In other embodiments, the rectification parameters may be applied to alignment parameters, thus, rectification parameters may include adjustments to alignment parameters (e.g., add-on or temporary calibration/adjustment/update).

In one or more embodiments, generating the rectification parameters may include determining a translation between the infrared image and the plurality of images (e.g., the first image and the second image). In some embodiments, the regression analysis may include a translation (alignment) between the first image (e.g., infrared image) and the second image (e.g., the visible spectrum image), which is derived using equation (1):

pan=C₀/z+C₁, (1)

where pan is image alignment (e.g., x and/or y translation between the first image and the second image), C₀ is a parallax error between the first image and the second image, C₁ is the pointing error between the first image and the second image, and z is the distance to object (e.g. focus distance). In some embodiments, pan, C₀, and C₁ may be expressed in pixels (e.g., x and y), and z may be expressed in meters. In some embodiments, the regression analysis may include a nonlinear least-squares regression, as shown in FIG. 6. As shown in FIG. 1, a parallax distance p may define the distance between the imaging devices (e.g., imaging cameras and/or sensors). The pointing error C₁ may include the difference between the original pointing direction (e.g., the pointing direction set by the manufacturer) and the changed pointing direction (e.g., the change in pointing direction caused by mechanical alteration of one or more of the imaging devices). The parallax error and/or pointing error may occur if, for example, one or more of the imaging devices are exposed to vibrations or other environmental/external strains.

In some embodiments, generating rectification parameters may include deriving pan when z is known, such that C₀ and C₁ may be optimized, as shown in graph 600 (e.g., fitted line plot).

In one or more embodiments, graph 600 includes x-axis values for d (e.g., z, or distance to target) and y-axis values for pan. Data points 602 indicate a plurality of misalignment data (e.g., spatial deviations) collected over a duration of time from a plurality of image pairs. The line indicates a curve of best fit based on the plurality of misalignment data and provides the rectification parameters (e.g., the updated fusion parameters). More specifically, the fitted curve 604 provides optimized C₀ and C₁, thus updating and/or optimizing at least the horizontal and vertical alignment of the combined image. Though generating rectification parameters is described using a regression analysis, as understood by one of ordinary skilled in the art, other methods may be used.

In other embodiments, generating rectification parameters may include parallax being constant while the remainder of the system is updated. More specifically, pan may be derived, while C₀ is known and fixed, such that z and C₁ are optimized.

In another embodiment, generating rectification parameters may include z (e.g., the distance to target) being incorrect and fixing pan, C₀ and C₁ so that z may be solved for.

As shown in FIG. 6, an example code associated with graph 600 is based on a nonlinear least-squares regression, which includes example data. The example code optimizes C₀ and C₁, providing updated fusion parameters to adjust the combined image, as previously discussed herein. The example rectification parameter function is set forth below.

$$\% - Synthetic data$$

$$C 0 = 10 ;$$

$$C 1 = 10 ;$$

$$ddata = 0.5 : 0.1 : 20 ;$$

$$noisedata = randn ( size ( ddata ) ) ;$$

$$pandata = ( C 0 + noisedata ) . / ddata + ( C 1 + noisedata ) ;$$

$$\% - Problem setup$$

$$C 0 = optim var ( {}^{‵} C {0}^{′} , 1 ) ;$$

$$C 1 = optim var ( {}^{‵} C {1}^{′} , 1 ) ;$$

$$fun = C 0. / ddata + C 1 ;$$

$$obj = sum ( ( fun - pandata ) . {}^{⋀} 2 ) ;$$

$$lsqproblem = optimproblem ( {}^{‶} {Objective}^{″} , obj ) ;$$

$$x 0. C 0 = 10 ; \% Initial point$$

$$x 0. C 1 = 10 ; \% Initial point$$

$$\% - Solve the problem$$

$$[ sol , fval ] = solve ( lsqproblem , x 0 ) ;$$

$$sol$$

$$\% - Plot$$

$$figure$$

$$responsedata = evaluate ( fun , sol ) ;$$

$$plot ( ddata , pandata , {}^{‵} {r}^{⋆ ′} , ddata , responsedata , {}^{‵} b {-}^{′} )$$

$$legend ( {}^{‵} Original {data}^{′} , {}^{‵} Fitted {curve}^{′} )$$

$$xlabel {}^{‵} {d}^{′}$$

$$ylabel {}^{‵} {pan}^{′}$$

In one or more embodiments, one or more spatial deviations may be stored in, for example, memory component 108. In some embodiments, spatial deviation and operation data of one or more of the imaging devices may be stored. Operation data may include camera settings (e.g., focus distance, lens distortion, white balance, shutter speed, ISO, aperture, and so on).

In one or more embodiments, logic device 104 may use decision support to detect if the spatial deviation (e.g., misalignment) is a temporal or spatial misalignment. For example, logic device 104 may be configured to determine if the misalignment is constant over time for, for example, different focus settings. For example, misalignment may remain constant despite the operation data associated with an imaging device. In another example, misalignment may vary based on the operation data (e.g., based on a focus setting of a focus distance z). Logic device 104 may then generate rectification parameters (e.g., updated rectification parameters) to improve alignment of the plurality of images during fusion for creating the combined image. In one or more embodiments, process 200 of FIG. 2 may be executed as many times as desired to collect samples to determine one or more characteristics of the misalignment (e.g., identify a trend of successive misalignments from a plurality of image pairs) and/or to generate rectification parameters. For example, after executing process 200, system 100 may wait for new focusing of one or more of the imaging devices (e.g., the infrared imaging device), or some other triggering of the algorithm (e.g., event), to repeat process 200.

FIG. 7 shows a block diagram of imaging system 100 in accordance with an embodiment of this disclosure. Imaging system 100 may include various components, such as, but not limited to, logic device 104, memory component 108, control component 106, communication component 110, display component 112, one or more imaging devices 114 (e.g., a plurality of imaging devices 114, such as a first imaging device and a second imaging device) configured to capture images 130, sensing components 116, and/or other components 120, as previously discussed in FIG. 1. In one or more embodiments, imaging devices 114 may include cameras configured to capture one or more images of scene 102. Imaging system 100 may be configured to capture and/or process images in accordance with one or more embodiments of the disclosure.

For instance, in some embodiments, environmental conditions may be less than ideal and result in the captured images having undesirable characteristics, such as low-light levels, that result in combined image being composed of pixels of combined image having pixel values that result in an overall dark image, making scene content (e.g., edges, objects, and so on) within the combined image difficult to identify and determine. Thus, image enhancement is significant for perception or interpretability of fusion images composed of images captured by one or more imaging devices in an environment with poor illumination (e.g., low illumination). To correct low perceivability or interpretability caused by low-light conditions, imaging system may include software that provides image enhancement (e.g., an alteration in brightness, contrast, noise, or the like). For example, the imaging system may include embedded software that, by analyzing images from each imaging device, can detect low visibility or low-light conditions and provide post-processing of one or more images to enhance the combined image.

In some embodiments, imaging system may automatically/autonomously determine and/or set, for example, image settings, using, for example, one or more trained machine learning models. The machine learning model(s) may be a neural network (e.g., an artificial neural network, convolutional neural network, transformer-type neural network, and/or other neural network), a decision tree-based machine model, and/or other machine learning models. In some cases, the type of machine learning model trained and used may be dependent on the type of data. Image settings may include, by way of non-limiting examples, measurement functions (e.g., spots, boxes, lines, circles, polygons, polylines) such as temperature measurement functions, image parameters (e.g., emissivity, reflected temperature, distance, atmospheric temperature, external optics temperature, external optics transmissivity), palettes (e.g., color palette, grayscale palette), temperature alarms (e.g., type of alarm, threshold levels), fusion modes (e.g., thermal/visual only, blending, fusion, picture-in-picture (PIP)), fusion settings (e.g., alignment, PIP placement), level and span/gain control, zoom/cropping, equipment type classifications, fault classifications, recommended actions, text annotations/notes, and/or others.

As previously discussed herein, by way of non-limiting examples, imaging devices 114 may be, may include, or may be a part of a visible-light imaging device (e.g., visible spectrum and/or visual camera), an infrared imaging device (e.g., an infrared or thermal camera), an ultraviolet (UV) imaging device (e.g., LWUV camera), a tablet computer, a laptop, a personal digital assistant (PDA), a mobile device, a desktop computer, or other electronic device utilized to capture one or more images of a scene (e.g., scene 102). For example, and without limitation, imaging devices 114 may include first imaging device 114a, such as a visible light (VIS) imaging device, and second imaging device 114b, such as an infrared (IR) imaging device. Visible light imaging device is configured to capture a visible light image (also referred to as a “visible spectrum image”), such as first image 130a, of scene 102, and infrared imaging device is configured to capture an infrared and/or thermal image of scene 102, such as second image 130b.

In one or more embodiments, each imaging device 114a,b may be positioned at a different locations relative to other imaging devices of system 100, where each imaging device 114a,b may provide a different perspective of scene 102. Alignment parameters may be provided, for example, by a user or manufacturer to facilitate combining images 130 (e.g., a first image and a second image) captured by the plurality of imaging devices 114 (e.g., visible light imaging device and infrared imaging device, respectively) based on the location (e.g., position and/or real-world location) of each imaging device relative to another imaging device of system 100 (e.g., physical location, orientation, angle, and/or the like of visible light imaging device relative to infrared imaging device). It will be appreciated that though system 100 is described as having two imaging devices herein, any number of imaging devices may be used without departing from the scope and spirit of the disclosure.

Each imaging device 114a,b may be configured to capture one or more images (e.g., image data) of a scene 102. In some embodiments, imaging devices 114 may include a focal plane array (FPA). In one or more embodiments, imaging devices 114 may include analog-to-digital converters to digitize an image captured by imaging devices. In one or more embodiments, imaging devices 114 may include one or more visible light imaging devices (e.g., visible spectrum imaging devices), infrared imaging devices (e.g., thermal imaging devices), ultraviolet imaging devices, any combination thereof, and the like. Additionally and/or alternatively, each imaging device 114 may include a two-dimensional (2D) camera, a three-dimensional (3D) camera, a four-dimensional (4D) scanner (e.g., a laser scanner configured to digitally capture the shape of an object and create point clouds of data), and so on.

As previously mentioned, imaging devices 114 may include infrared imaging device (e.g., second imaging device 114b), which may include one or more infrared sensors (e.g., any type of multi-pixel infrared detector, such as a focal plane array) for capturing infrared image data (e.g., still image data and/or video data) representative of infrared image 130b of scene 102. In one or more embodiments, infrared imaging device may convert captured infrared image data as digital data (e.g., via an analog-to-digital converter included as part of the infrared sensor or separate from the infrared sensor as part of system 100). In one aspect, the infrared image data (e.g., infrared video data) may include non-uniform data (e.g., real image data) of an infrared image. Logic device 104 may be configured to process thermal (e.g., infrared) and/or non-thermal (e.g., visible light) image data (e.g., to provide processed image data), store the image data in the memory component 108, and/or retrieve stored image data from the memory component 108.

In various embodiments, logic device 104 may be communicatively connected to any other components of imaging system 100, as previously discussed in FIG. 1. Logic device 104 may be configured to interface and communicate with any of the various components (e.g., components 106, 108, 110, 112, 116, 118, 120, 128, and so on) of imaging system 100 to perform such operations. For example, logic device 104 may be configured to process captured image data (e.g., one or more images and/or or videos) received from imaging devices 114, store the image data in memory component 108, and/or retrieve stored image data from memory component 108. In one aspect, logic device 104 may be configured to perform various system control operations (e.g., to control communications and operations of various components of imaging system 100) and other image processing operations (e.g., video analytics, data conversion, data transformation, data compression, and the like). For example, logic device 104 may use machine-learning modules and/or neural networks 124 (e.g., convolutional neural network (CNN)) to process one or more images provided by imaging devices 114. For example, logic device 104 may use artificial neural networks (ANNs) (e.g., neural networks 124), as described further herein below.

In one or more embodiments, memory component 108 may include one or more memory devices configured to store data and information, including image data and information, as previously discussed in FIG. 1. As discussed above, logic device 104 may be configured to execute software instructions stored in memory component 108 so as to perform method and process steps and/or operations. Logic device 104 and/or imaging devices 114 may be configured to store in memory component 108 images, or image data (e.g., digital image data), captured by imaging devices 114. In some embodiments, memory component 108 may store various infrared images, visible-light images, ultraviolet images, combined/fusion images (e.g., non-visible light images blended with visible-light images), image settings, image features, quality characteristics, enhanced combined images, system parameters, user input, sensor data, training datasets, historical data, and/or any other data or information discussed herein.

In various embodiments, memory component 108 may be adapted to store databases, such as database 126 or other data. Other data may include any data or information (e.g., instructions) used by system 100 (e.g., logic device 104) to perform any processes, steps, and/or sequences of steps described herein. For example, in some embodiments, other data may include training data (also referred to herein as “training sets” or “training data sets”) used for generating and/or training of neural networks described in this disclosure. For instance, training data may include training data 828, 898, and 822 used for generating and/or training ANNs 880, 810, 820, shown in FIG. 8.

As previously discussed in FIG. 1, the detector output image may be, or may be considered, a data structure that includes pixels and is a representation of the image data associated with scene 102, with each pixel having a pixel value that represents EM radiation emitted or reflected from a portion of scene 102 and received by a detector that generates the pixel value. Based on context, a pixel may refer to a detector of the image detector circuit that generates an associated pixel value or a pixel (e.g., pixel location and/or pixel coordinate) of the detector output image formed from the generated pixel values. In one example, the detector output image may be an infrared image (e.g., thermal infrared image). For an infrared image, each pixel value of the thermal infrared image may represent a temperature of a corresponding portion of scene 102. In another example, the detector output image may be a visible-light image where each pixel value represents a color and/or intensity corresponding to a portion of scene 102.

In various embodiments, display component 112 may include an image display device (e.g., a liquid crystal display (LCD)) or various other types of generally known video displays or monitors. Logic device 104 may be configured to display image data and/or information on display component 112. The logic device 104 may be configured to retrieve image data and information from memory component 108 and display any retrieved image data and information on display component 112. Display component 112 may include display circuitry, which may be utilized by logic device 104 to display image data and information. Display component 112 may be adapted to receive image data and information directly from the imaging devices 114, logic device 104, memory component 108, a system interface (e.g., control component 106) receiving user input, or the like. In some aspects, control component 106 may be implemented as part of display component 112 (e.g., touchscreen, keyboard, mouse, joystick, switches, buttons, and the like). For example, a touchscreen of control component 106 may be configured to receive user input via taps and/or other gestures to navigate a graphic user interface of display component 112 and/or control logic device 104, imaging devices 114, or any other components of system 100.

For example, control component 106 may include a user input and/or an interface device. A user interface may include, but is not limited to, a rotatable knob (e.g., potentiometer), push buttons, slide bar, keyboard, and/or other devices, that is adapted to generate a user input control signal. Logic device 104 may be configured to sense control input signals from a user via the control component 106 and respond to any sensed control input signals received therefrom. Logic device 104 may be configured to interpret such a control input signal as a value, as generally understood by one skilled in the art. In one embodiment, the control component may include a control unit (e.g., a wired or wireless handheld control unit) having push buttons adapted to interface with a user and receive user input control values. In one implementation, the push buttons and/or other input mechanisms of the control unit may be used to control various functions of the imaging devices 114, such as calibration initiation and/or related control, shutter control, autofocus, menu enable and selection, field of view, brightness, contrast, noise filtering, image enhancement, and/or various other features. In some cases, the control component 106 may be used to provide user input (e.g., for adjusting image settings).

In one or more embodiments of the present disclosure, imaging system 100 may include sensing components 116. In various embodiments, sensing components 116 may include one or more sensors of various types, depending on the application or implementation requirements, as would be understood by one skilled in the art. Sensors of sensing components 116 may be configured to provide data and/or information to at least logic device 104. In one aspect, logic device 104 may be configured to communicate with sensing components 116. Sensing components may include a light sensor, global positioning system (GPS), gyroscope, accelerometer, Light Detection and Ranging (LIDAR), laser scanner, radio detection and ranging (RADAR), range finder, ultrasonic imaging device, and/or the like.

In some embodiments, information provided by other sensing components may be used to provide operation data (e.g., operation data 320a,b from FIG. 3 and/or mode data 802, as shown in FIG. 8) and/or environmental data associated with environmental conditions of scene 102. Sensing components 116 may represent conventional sensors as generally known by one skilled in the art for monitoring various conditions (e.g., environmental conditions, such as lighting conditions) that may have an effect (e.g., on the image appearance) on the image data provided by the imaging devices and/or provide past or current operation data, as discussed further below in this disclosure.

In a non-limiting example, light sensor may include one or more types of light sensors, such as photodiodes, photoresistors, photovoltaic light sensors, and the like. Light sensor may be implemented to determine lighting conditions of an environment (e.g., scene 102). For example, in some embodiments, logic device 104 may identify low-light conditions based on received sensor data from sensing components 116 (e.g., one or more light sensors) to determine that image enhancement needs to be performed to improve visibility and/or perceivability of a combined image 732 (e.g., combined image 132 from FIG. 1 and/or updated/adjusted combined image 328 from FIG. 3).

In some implementations, sensing components 116 (e.g., one or more sensors) may include devices that relay information to logic device 104 via wired and/or wireless communication. For example, sensing components 116 may be adapted to receive information from a satellite, through a local broadcast (e.g., radio frequency (RF)) transmission, through a mobile or cellular network and/or through information beacons in an infrastructure (e.g., a transportation or highway information beacon infrastructure), or various other wired and/or wireless techniques. In some embodiments, logic device 104 can use the information (e.g., sensing data) retrieved from sensing components 116 to modify a configuration of the image capture component (e.g., adjusting a light sensitivity level, adjusting a direction or angle of the imaging devices, adjusting an aperture, and/or the like).

Imaging system 100 may include various other components 182 such as speakers, additional displays, visual indicators (e.g., recording indicators), vibration actuators, a battery or other power supply (e.g., rechargeable or otherwise), and/or additional components as appropriate for particular implementations.

FIG. 8 illustrates a block diagram of an example embodiment of system 100, which is configured to enhance a combined image (e.g., combined images 132, 328, or 732) taken in low lighting in accordance with one or more embodiments of the present disclosure. When there is little or no daylight and/or ambient light, such as at night or when there are other environmental conditions reducing the available visible light, imaging system 100 may be adapted to provide combined images and/or video that include real-time infrared images, or components thereof, blended with adjusted visible light images, or components thereof. For example, a radiometric luminosity (intensity) component of infrared image may be blended with a chrominance (color) component of corresponding visible light image, or vice versa, such that the resulting combined image contains infrared imagery blended with representative visible light colors.

In various embodiments, system 100 may be configured to detect an amount of available ambient light and/or daylight of an environment of, for example, scene 102. For instance, different received images, such as images 130a,b, may be blended together according to a measure of available light identified in combined image 732. In some embodiments, system 100 may be configured to use different sets of processing methodology with respect to different portions of captured images depending on an amount of available ambient light and/or daylight detected in at least a portion of received images 130a,b. In further embodiments, system 100 may be configured to select and/or morph at least a portion of images 130a,b based on various information (e.g., sensor data from sensing components 116, identification of a luminance component of one or more images 130a,b by logic device 104, image data from imaging devices 114, and/or information determined by other components 120) and/or based on various processing operations. In such embodiments, imaging system 100 may be configured to implement one or more pre-processing and/or post-processing methodologies with and/or without user input (e.g., in response to machine-based input), as described herein.

In one or more embodiments, logic device 104 may be configured to receive a plurality of images 130, such as image pair 130a,b. In various embodiments, image pair may include first image 130a, such as a light (VIS) image 830a, and second image 130b, such as an infrared (IR) image 830b. In some embodiments, images 130a,b may include pre-processed images. For example, logic device 104 may be configured to receive one or more visible light images from first imaging device 114a and one or more infrared images from second imaging device 114b.

In one or more embodiments, infrared imaging device 814b may include infrared sensors configured to detect infrared radiation (e.g., infrared energy) from a target scene, such as scene 102, including, for example, mid-wave infrared wave bands (MWIR), long wave infrared wave bands (LWIR), and/or other thermal imaging bands as may be desired in particular implementations. In one embodiment, second imaging device 114b (e.g., infrared imaging device 814b) may be provided in accordance with wafer level packaging techniques. For instance, infrared imaging device 814b may include infrared sensors that may be implemented, for example, as microbolometers or other types of thermal imaging infrared sensors arranged in any desired array pattern to provide a plurality of pixels. Infrared imaging device 814b may include infrared circuits that may include a substrate having various circuitry, including, but not limited to, a read out integrated circuit (ROIC). Further descriptions of ROICs and infrared sensors (e.g., microbolometer circuits) may be found in U.S. Pat. No. 6,028,309 issued Feb. 22, 2000, which is incorporated herein by reference in its entirety. In various embodiments, infrared imaging device 814b and/or associated components may be implemented in accordance with various techniques (e.g., wafer level packaging techniques) as set forth in U.S. Pat. No. 8,743,207 issued Jun. 3, 2014, which is incorporated herein by reference in its entirety. Infrared imaging device 814b may be configured to store and/or transmit captured infrared images according to a variety of different color spaces/formats, such as YCbCr, RGB, and YUV, for example, where radiometric data may be encoded into one or more components of a specified color space/format. In some embodiments, a common color space may be used for storing and/or transmitting infrared images and visible light images.

In various embodiments, radiometric data of IR image 830b captured by infrared imaging device 814b may be encoded into both luminance and chrominance components (e.g., Y and Cr and Cb). For example, infrared imaging device 814b may be configured to sense infrared radiation across a particular band of infrared frequencies, as previously mentioned. A luminance component may include radiometric data corresponding to intensity of infrared radiation, and a chrominance component may include radiometric data corresponding to what frequency of infrared radiation is being sensed (e.g., according to a pseudo-color palette). In such an embodiment, a radiometric component of the resulting infrared image may include both luminance and chrominance components of the infrared image. In one or more embodiments, luminance component may include intensity values, where each intensity value of the plurality of intensity values is associated with a corresponding pixel of the infrared image.

In one or more embodiments, first imaging device 114a may include a non-thermal camera (e.g., visible light imaging such as visible light imaging device 814a or other type of non-thermal imager). The non-thermal camera may be a small form factor imaging module or imaging device, and may, in some embodiments, be implemented in a manner similar to the various embodiments of infrared imaging device 814b disclosed herein, with one or more sensors and/or sensor arrays responsive to radiation in non-thermal spectrums (e.g., radiation in visible light wavelengths, ultraviolet wavelengths, and/or other non-thermal wavelengths). For example, in some embodiments, the non-thermal camera may be implemented with a charge-coupled device (CCD) sensor, an electron multiplying CCD (EMCCD) sensor, a complementary metal-oxide-semiconductor (CMOS) sensor, a scientific CMOS (sCMOS) sensor, or other filters and/or sensors. In some embodiments, visible light imaging device 814a may include an FPA of visible spectrum sensors, for example, and may be configured to capture, process, and/or manage visible spectrum images of scene 102. Visible light imaging device 814a may be configured to store and/or transmit captured visible spectrum images according to a variety of different color spaces/formats, such as YCbCr, RGB, and YUV, for example, and individual visible spectrum images may be colored, corrected, and/or calibrated according to their designated color space and/or pixel values corresponding affected by visible light of scene 102.

In some embodiments, the non-thermal camera may be co-located with infrared imaging device 814b and oriented such that a field-of-view (FOV) 122a of the non-thermal camera (e.g., visible imaging device) at least partially overlaps a FOV 122b of infrared imaging device 814b, as shown in FIGS. 1 and 7.

In one embodiment, visible spectrum and/or infrared images may be pre-processed. For instance, once the visible light (VIS) image 830a and IR image 830b are transmitted by imaging devices 814a,b, respectively, and received by logic device 104, logic device 104 may be configured to retrieve or determine a mode (e.g., mode data 802) for generating one or more combined images, such as combined image 732. Such mode may be selected by a user, retrieved from database 126, or determined, by logic device 104, based on context data or a mode of operation of imaging devices 814a,b. In various embodiments, pre-combining operations may include applying a high pass filter, applying a low pass filter, applying a non-linear low pass filer (e.g., a median filter), adjusting dynamic range (e.g., through a combination of histogram equalization and/or linear scaling), scaling dynamic range (e.g., by applying a gain and/or an offset), and adding image data derived from these operations to each other to form processed images.

In one or more embodiments, logic device 104 may be configured to generate combined image 732. For instance, logic device 104 may be configured to combine (e.g., blend) one or more visible light images with one or more infrared images (e.g., blend visible light image 830a and infrared image 830b based on blending parameters provided, for example, by memory component 108). In other embodiments, logic device 104 may be configured to generate a combined image by combining images 830a,b using rectification parameters, as previously discussed in FIGS. 1-6.

In one embodiment, combining images 830a,b may include adding a radiometric component of infrared image 830b to a corresponding component (e.g., chrominance) of visible light image 830a, based on fusion parameters, which may be retrieved from memory component 108 (e.g., database 126) and implemented by logic device 104, such as using fusion ANN 880. For example, a radiometric component of IR image 830b may include a luminance component of infrared image 830b. In such an embodiment, blending IR image 830b with VIS image 830a may include proportionally adding the luminance components of images 830a,b according to the blending parameter. In other embodiments, where a radiometric component of IR image 830b may not be a luminance component, blending IR image 830b with VIS image 830a may include adding chrominance components of images 830a,b by, for example, replacing luminance components with corresponding chrominance components corresponding images. More generally, blending may include adding (e.g., proportionally) a component of IR image 830b, which may be a radiometric component of IR image 830b, to a corresponding component of first image 130a (e.g., VIS image 830a). Once blended image data is derived from the components of images 830a,b, the blended image data may be encoded into a corresponding component of combined image 732. In some embodiments, encoding blended image data into a component of combined image 732 may include additional image processing steps, for example, such as dynamic range adjustment, normalization, gain and offset operations, and color space conversions, for instance.

As previously mentioned, logic device 104 may use fusion ANN 880 to combine images 830a,b to create combined image 732. Fusion ANN 880 may be created using for example, a training dataset (also referred to herein as “training data”), such as fusion training dataset 828, which may include example image inputs that are correlated to corresponding example combined image outputs. Fusion ANN 880 may include or be similar to the neural networks described herein (e.g., FIG. 5).

In one or more embodiments, logic device 104 may be configured to derive high spatial frequency content from one or more of images 830a,b. For example, if a high contrast mode associated with mode data 802 is determined as implemented, logic device 104 may be configured to derive high spatial frequency content from one or more of images 830a,b. In one embodiment, high spatial frequency content may be derived from an image by performing a high pass filter (e.g., a spatial filter) operation on the image, where the result of the high pass filter operation is the high spatial frequency content. In an alternative embodiment, high spatial frequency content may be derived from an image by performing a low pass filter operation on the image, and then subtracting the result from the original image to get the remaining content, which is the high spatial frequency content. In another embodiment, high spatial frequency content may be derived from a selection of images through difference imaging, for example, where one image is subtracted from a second image that is perturbed from the first image in some fashion, and the result of the subtraction is the high spatial frequency content. Further descriptions of high spatial frequency content may be found in U.S. Pat. No. 9,635,285 issued Apr. 25, 2017, and U.S. Pat. No. 10,244,190 issued Mar. 26, 2019, which are incorporated herein by reference in their entirety.

In various embodiments, logic device 104 may be configured to blend high spatial frequency content from VIS image 830a with IR image 830b. In one embodiment, high spatial frequency content may be blended with infrared images by superimposing the high spatial frequency content onto the infrared images, where the high spatial frequency content replaces or overwrites those portions of the infrared images corresponding to where the high spatial frequency content exists. In one or more embodiments, images 830a,b may be overlayed using alignment parameters 804 (e.g., alignment parameters 326 from FIG. 3) and/or rectification parameters 324 from, for example, database 126, which can be used to align corresponding scene content (e.g., a point, surface, edge, object, and/or the like) of images 830a,b with each other to aid in creating a cohesive combined image 732 (e.g., updated combined image 328).

In one or more embodiments, logic device 104 may de-noise one or more infrared images. For example, logic device 104 may be configured to de-noise, smooth, or blur one or more infrared images 830b of scene 102 using a variety of image processing operations. In one embodiment, removing high spatial frequency noise from infrared images allows processed infrared image 830b to be combined with high spatial frequency content derived with significantly less risk of introducing double edges (e.g., edge noise) to objects depicted in combined image 732 of scene 102. In one embodiment, removing noise from infrared images may include performing a low pass filter (e.g., a spatial and/or temporal filter) operation on the image, where the result of the low pass filter operation is a de-noised or processed infrared image. In a further embodiment, removing noise from one or more infrared images may include down-sampling the infrared images and then up-sampling the images back to the original resolution.

In some embodiments, logic device 104 may be configured to identify one or more quality characteristics of combined image 732. In some embodiments, a neural network (as described further in FIG. 3) may be used by logic device 104 and may be configured to identify one or more quality characteristics of combined image 732 based on the various image analytics. For instance, a quality characteristic of combined image 732 may include a luminance characteristic, where a luminance characteristic includes one or more intensity values of one or more corresponding pixels of combined image 732. Luminance characteristic may be analyzed based on an overall (global) luminance and/or based on individual pixel values of combined image 732. In various embodiments, logic device 104 may be configured to identify a quality characteristic (e.g., luminance characteristic) of combined image 732 based at least a predetermined threshold (e.g., luminance threshold 806). For instance, logic device 104 may be configured to compare luminance characteristic (e.g., one or more pixel intensity values) of combined image 732 to, for example, luminance threshold 806.

Luminance threshold 806 may include a quantitative value or range of values that logic device 104 may compare the one or more quality characteristics of combined image 732 to as a standard (e.g., a minimum intensity value of combined image 732). For instance, if an average value of pixel intensity of combined image 732 is outside of (e.g., below) luminance threshold 806, then logic device 104 may identify that luminance characteristic is outside of luminance threshold 806 and, in response, determine a deviation element 808 (e.g., luminance deviation element). Deviation element 808 may indicate the quantity by which combined image 732 is outside of luminance threshold. Further deviation element 808 may indicate which specific pixels and/or group of pixels affect the luminance characteristic of combined image 732, causing it to be outside of luminance threshold 806.

More specifically, logic device 104 may be configured to determine if the luminance component associated with global luminance and/or individual pixel values of combined image 732 is below the luminance threshold. If the luminance component is below the luminance threshold, then logic device 104 may be configured to determine a luminance deviation element based on the comparison. As discussed further below, logic device may use a machine learning model, such as a deviation artificial neural network 810 to determine the deviation element 808. In various embodiments, deviation ANN 810 may be created using for example, a training dataset (also referred to herein as “training data”), such as deviation training data 898, which may include example quality characteristic inputs that are correlated to corresponding example deviation element outputs. Deviation ANN 810 may include or be similar to the neural networks described further with respect to FIG. 3. Threshold 806 may be selected by a user via user input, retrieved from memory component 108 (e.g., database 126), determined by logic device 104, and/or the like.

In one or more embodiments, quality characteristics of combined image 732 may include, but are not limited to, luminance/brightness/intensity (e.g., luminance component, as discussed previously in this disclosure), sharpness, noise, image blur, and/or the like of combined image 732 to determine if the quality (e.g., perceivability) of combined image 732 is sufficient for viewing by a user. As previously mentioned, determining a quality of each of combined image 732 may include comparing one or more quality characteristics of combined image 732 to predetermined threshold 806. Quality characteristics may include a qualitative and/or quantitative predetermined standard and/or tolerance for quality of an image. Quality characteristics may be provided by a user (e.g., manual user input) and/or the manufacturer. Quality characteristics may include a tolerance associated with focus distance, image blur, brightness/luminance/intensity, contrast, sharpness, and/or the like of the image.

In some embodiments, determining one or more quality characteristics of combined image 732 may include detecting features (e.g., feature points) of combined image 732. Features may include points, edges, corners, and the like. For example, features may include a characteristic of an object within scene 102 and thus combined image 732, as discussed further below herein.

In one or more embodiments, logic device 104 may be configured to determine corrective parameters 816 based on VIS image 830a and/or IR image 830b and deviation element 808. Corrective parameters 816 may refer to information (e.g., an algorithm) for adjusting images in order to eliminate deviation element 808. In some embodiments, corrective parameters 816 may be stored in memory component 108, such as database 126, and used to update fusion ANN 880 (e.g., as an updated training dataset) to adjust combined image 732.

In other embodiments, corrective parameters 816 may be used by enhancement ANN 820, which is configured to adjust images 830 to created adjusted image(s) 818. For instance, logic device 104 may be configured to adjust a luminance component of VIS image 830a based on corrective parameters 816, where adjusting the luminance component may include adjusting one or more intensity values of one or more corresponding pixels of VIS image 830a. In one or more embodiments, adjusting one or more intensity values of VIS image 830a may result in an increased contrast and/or brightness of image VIS image 830a, as shown in FIG. 8. In one or more embodiments, adjusted image 818 (such as adjusted VIS image 818a or adjusted IR image 818b) may be stored in memory component 108 (e.g., database 126). Adjusted image 818 may then be recalled by logic device in a later process to generate enhanced image 832.

In one or more embodiments, corrective parameters 816 may be used based on feedback (e.g., determination of deviation element 808). If deviation element remains zero, then corrective parameters 816 may be used by logic device 104. If deviation element is greater than zero, then corrective parameters may be updated based on the deviation element. In some embodiments, corrective parameters may also be changed based on alterations in alignment parameters 804 or mode data (mode of operation of imaging device 114), sensor data (e.g., environmental conditions detected by one or more sensors), manual user input, and so on.

In other embodiments, logic device 104 may be configured to adjust noise of VIS image 830a and/or IR image 830b based on other quality characteristics (e.g., noise characteristics associated with noise levels of combined image 732). For example, logic device 104 may be configured to compare a noise component of combined image 732 to a noise threshold, determine, if the noise component is outside of the noise threshold, determine a noise deviation element based on the comparison, and adjust one or more features of, for example, VIS image 830a by, for example, reducing a noise level of the at least a portion of the VIS image based on the noise deviation element.

In some embodiments, logic device 104 may be configured to adjust one or more components of at least a portion of one or more images 830a,b based on deviation element 808 and/or correction parameters 816. In various embodiments, images 830a,b may be adjusted using post-processing operations similar to those used to process image data and/or generate combined image 732, as previously discussed herein. For instance, in some embodiments, post-processing operations may include applying a high pass filter, applying a low pass filter, applying a non-linear low pass filter (e.g., a median filter), adjusting dynamic range (e.g., through a combination of histogram equalization and/or linear scaling), scaling dynamic range (e.g., by applying a gain and/or an offset), adjusting luminance/brightness, adding contrast, and adding image data derived from these operations to each other to form processed images based on images 830a,b, respectively, and deviation element 808. For instance, continuing the example describe above of the luminance component of combined image 732 being below the luminance threshold, VIS image 830a may be adjusted accordingly. For example, contrast and/or intensity of VIS image 830a may be adjusted such that scene content of image 830a is more readily visible. As discussed further below, logic device may use a machine learning model, such as an enhancement neural network 820 to adjust images 830a,b based on deviation element 808. In various embodiments, enhancement ANN 820 may be created using, for example, a training dataset (also referred to herein as “training data”), such as enhancement training data 822, which may include example corrective parameter inputs and image inputs that are correlated to corresponding example adjusted image outputs.

In one or more embodiments, logic device 104 may be configured to generate enhanced combined image 832 (also referred to herein as a “enhanced image”). In some embodiments, enhanced combined image 832 may be generated based on adjusted images 830, such as adjusted VIS image 818a and/or adjusted IR image 818b. Generating enhanced combined image 832 based on at least adjusted images 818 (e.g., VIS image 818a) creates an updated combined image (e.g., combined image 732 is updated) with sufficient radiometric data, luminance data, and/or chrominance data so that scene content of enhanced image 832 provides improved perceivability compared to combined image 732. For instance, enhanced image 832 may have an increased brightness and/or contrast relative to combined image 732, which allows a user viewing enhanced combined image 832 on, for example, display component 112, to more easily identify, detect, and/or read scene content therein (e.g., objects, edges, lines, points, and so on), as discussed further below.

In one or more embodiments, an enhanced combined image 832 may be generated based on images 830 (e.g., VIS image 830a and/or IR image 830b) and/or adjusted images 818 (e.g., adjusted VIS image 818a and/or IR image 818b). For instance, continuing the example described above, logic device 104 may be configured to generate, using fusion ANN 880, enhanced image 832 based on adjusted image 818a and IR image 830b. In one or more embodiments, luminance components, radiometric components, and/or chrominance components of the thermal (e.g., IR image 830b) and adjusted non-thermal images (e.g., adjusted VIS image 818a) may be combined according to blending parameters to create enhanced combined image 832.

In various instances, generating enhanced image 832 may include extracting details and background portions (e.g., background scene content) from a radiometric component of initial infrared image using a high pass spatial filter, performing histogram equalization and scaling on the dynamic range of the background portion, scaling the dynamic range of the details portion, adding the adjusted background and details portions to form a processed infrared image, and then linearly mapping the dynamic range of the processed infrared image to the dynamic range of display component 112 of system 100. In one embodiment, the radiometric component of the infrared image 830b may be a luminance component of infrared image 830b, and the chrominance component of adjusted image 818a may be blended with processed infrared image 830b to create enhanced combined image 832.

Regarding high contrast processing, high spatial frequency content may be obtained from one or more of the thermal and non-thermal images (e.g., by performing high pass filtering, difference imaging, and/or other techniques) to create enhanced combined image 832 in a process similar or the same as the process described above in regard to generating combined image 732. For instance, in some embodiments, high spatial frequency content from non-thermal images may be blended with thermal images by superimposing the high spatial frequency content onto the thermal images, where the high spatial frequency content replaces or overwrites those portions of the thermal images corresponding to where the high spatial frequency content exists. For example, a radiometric component of thermal image may be a chrominance component of the thermal image, and the high spatial frequency content may be derived from the luminance.

In one or more embodiments, logic device 104 may transmit enhanced image data (e.g., enhanced image 832) to display component 112 for viewing by a user. For instance, display component 112 may be configured to display image pair 830a,b simultaneously (e.g., overlayed or juxtaposed), combined image 732, enhanced combined image 832, deviation element 808, corrective parameters 816, mode data, and the like. In another example, first image, the second image, the combined image, and/or the updated/enhanced combined image may be displayed side-by-side, picture-in-picture, vertically stacked, overlayed, and/or in any other configurations.

In one or more embodiments, displaying information and/or images on display component 112 may include providing visual annotations, such as highlighting, flagging, or otherwise noting differences between the first and second image and/or the combined image and/or the updated combined image. In some embodiments, the differences between the image and corresponding threshold (e.g., deviation element) may be detected using a processor (e.g., logic device 104), such as via a neural network running a machine learning algorithm or other artificial intelligence, as discussed further herein. Visual annotations may further include annotating or otherwise isolating the detected difference and/or allow a user to circle or annotate the detected difference between one or more displayed images.

In some embodiments, logic device 104 may be configured to convert visible spectrum, infrared, and/or combined images of system 100 into user-viewable images (e.g., thermograms) using appropriate methods and algorithms. For example, thermographic data contained in infrared and/or combined images may be converted into gray-scaled or color-scaled pixels to construct images that can be viewed on a display. User-viewable images may optionally include a legend or scale that indicates the approximate temperature of a corresponding pixel color and/or intensity. Such user-viewable images, if presented on a display (e.g., display component 112), may be used to confirm or better understand conditions of scene 102 detected by system 100.

Display component 112 may be configured to present, indicate, or otherwise convey combined images and/or associated information generated by logic device 104. In one embodiment, display component 112 may be implemented with various lighted icons, symbols, indicators, and/or gauges which may be similar to conventional indicators, gauges, and warning lights of a conventional monitoring system. The lighted icons, symbols, and/or indicators may indicate one or more notifications or alarms associated with the combined images and/or monitoring information. The lighted icons, symbols, or indicators may also be complemented with an alpha-numeric display panel (e.g., a segmented LED panel) to display letters and numbers representing other monitoring information, such as a temperature reading, a description or classification of detected conditions, etc.

In one or more embodiments, system 100 may be configured to perform image rectification, as discussed in FIGS. 1-6, in combination with low-light image enhancement to produce enhanced combined images with improved alignment and perceivability. For instance, logic device 104 may be configured to receive image pair (e.g., first image from first imaging device 114a and second image from second imaging device 114b), create a combined image based on alignment parameters and the image pair, identify features in the first image and the second image, calculate a spatial deviation based on the identified features, and generate rectification parameters based on the spatial deviation when the spatial deviation exceeds a predetermined threshold. In some embodiments, the rectification parameters may be applied to adjust the combined image, and the adjusted combined image (e.g., updated combined image) may then be evaluated for quality characteristics such as luminance components. If the luminance component of the adjusted combined image is below a luminance threshold, logic device 104 may determine a deviation element and generate corrective parameters to adjust one or more features of the first image, the second image, and/or the updated combined image, such as by increasing contrast and/or brightness. In some embodiments, the adjusted images may then be combined using the rectification parameters to generate an enhanced combined image that exhibits both improved alignment and improved perceivability.

In various embodiments, the image rectification and low-light enhancement processes may be performed iteratively or in a coordinated manner. For example, logic device 104 may first perform rectification operations to align the image pair based on detected features and calculated spatial deviations, and subsequently perform enhancement operations to improve the luminance and contrast characteristics of the rectified combined image (e.g., updated combined image 328). In some cases, the enhancement operations may be performed on the individual images of the image pair prior to combining, such that the adjusted VIS image and/or adjusted IR image are combined using the rectification parameters thereafter to create the enhanced combined image. In other cases, the enhancement operations may be performed after the rectification operations, such that the combined image is first adjusted based on rectification parameters and then further adjusted based on corrective parameters derived from the deviation element. The order and combination of rectification and enhancement operations may be determined based on, for example, mode data, sensor data indicating environmental conditions, user input and/or selections, and/or other factors.

For instance, in some embodiments, the method includes receiving an image pair of a scene, the image pair comprising a first image from a first imaging device and a second image from a second imaging device; creating a combined image based on alignment parameters and the image pair; identifying a first feature in the first image and a second feature in the second image; calculating a spatial deviation based on the first feature and the second feature; generating, if the spatial deviation exceeds a predetermined threshold, rectification parameters based at least on the spatial deviation; and adjusting the combined image based on at least the rectification parameters.

The first image may include a visible light (VIS) image of the scene captured using a VIS imaging device and the second image comprises an infrared (IR) image of the scene captured using an IR imaging device; the combined image comprises one or more quality characteristics. The method may further include adjusting one or more components of at least a portion of the VIS image based on the one or more quality characteristics of the combined image; and generating an enhanced combined image based on at least the adjusted VIS image.

In some embodiments, the one or more quality characteristics of the combined image comprises a luminance characteristic and the one or more components of the portion of the VIS image comprises a contrast. The method may further include comparing the luminance characteristic of the combined image to a luminance threshold; determining, if the luminance characteristic is outside of the luminance threshold, a luminance deviation element based on the comparison; and wherein the adjusting the one or more components includes increasing the contrast of the portion of the VIS image based on the luminance deviation element.

In some embodiments, the luminance characteristic may include a plurality of intensity values, wherein each intensity value of the plurality of intensity values is associated with a corresponding pixel of the combined image. Adjusting the one or more components by increasing the contrast may include providing a training dataset comprising low-light image inputs correlated to contrast enhancement image outputs; training a contrast enhancement convolutional neural network (CNN) using the training dataset; and increasing, using the contrast enhancement CNN, the contrast of the at least the portion of the VIS image.

In some embodiments, the method includes receiving operation data associated with one or more image settings of the first imaging device and the second imaging device; and storing the spatial deviation and the operation data. The operation data may include focus settings of the first imaging device and the second imaging device. The image pair may include a first image pair and the spatial deviation comprises a first spatial deviation. In some embodiments, the method includes receiving a second image pair of the scene, the second image pair comprising a third image from the first imaging device and a fourth image from the second imaging device; creating a second combined image based on the second image pair and the alignment parameters; identifying a third feature in the third image and a fourth feature in the fourth image; determining a second spatial deviation based on at least the third feature and the fourth feature; storing the second spatial deviation; and identifying a constant misalignment associated with a specific duration of time and/or the operation data; and adjusting the combined image based on the rectification parameters if the constant misalignment is identified.

In some embodiments, the method may include calculating the spatial deviation may include comparing a position of the first feature to a position of the second feature, wherein the spatial deviation comprises a horizontal translation and/or a vertical translation.

In some embodiments, the method may include wherein the adjusting the combined image includes altering the alignment parameters based on the rectification parameters; and creating an updated combined image based on the altered alignment parameters.

In some embodiments, the system includes a set of imaging devices, the set of imaging devices including a first imaging device configured to capture a first image of a scene and a second imaging device configured to capture a second image of the scene and a logic device communicatively connected to the set of imaging devices, wherein the logic device is configured to: receive the image pair of the scene from the imaging devices; create a combined image based on alignment parameters and the image pair; identify a first feature of the first image and a second feature of the second image; determine a spatial deviation based on the first feature and the second feature; generate rectification parameters based on at least the spatial deviation; and adjust the combined image based on at least the rectification parameters.

The first image comprises a visible light (VIS) image of the scene captured using a VIS imaging device and the second image comprises an infrared (IR) image of the scene captured using an IR imaging device. The combined image includes one or more quality characteristics. The logic device is further configured to adjust one or more components of at least a portion of the VIS image based on the one or more quality characteristics of the combined image and generate an enhanced combined image based on at least the adjusted VIS image.

The one or more quality characteristics of the combined image may include a luminance characteristic and the one or more components of the portion of the VIS image comprises a contrast. The method may include comparing the luminance characteristic of the combined image to a luminance threshold, and determining, if the luminance characteristic is outside of the luminance threshold, a luminance deviation element based on the comparison. The adjusting the one or more components includes increasing the contrast of the portion of the VIS image based on the luminance deviation element.

The luminance component (e.g., characteristic) may include a plurality of intensity values, wherein each intensity value of the plurality of intensity values is associated with a corresponding pixel of the combined image. The adjusting the one or more components by increasing the contrast may include providing a training dataset including low-light image inputs correlated to contrast enhancement image outputs; training a contrast enhancement convolutional neural network (CNN) using the training dataset; and increasing, using the contrast enhancement CNN, the contrast of the at least the portion of the VIS image.

The logic device is configured to receive operation data associated with one or more image settings of the first imaging device and the second imaging device when the image pair is captured and store the spatial deviation and corresponding operation data. The first operation data comprises a focus setting of the first imaging device and/or the second imaging device. The image pair may include a first image pair and the spatial deviation comprises a first spatial deviation.

The logic device may be configured to receive a second image pair of the scene, the second image pair including a third image from the first imaging device and a fourth image from the second imaging device; create a second combined image based on the second image pair and the alignment parameters; identify a third feature in the third image and a fourth feature in the fourth image; determine a second spatial deviation based on at least the third feature and the fourth feature; store the second spatial deviation; identify a constant misalignment associated with a specific duration of time and/or the operation data; and adjust the combined image based on the rectification parameters if the constant misalignment is identified.

In some embodiments, calculating the spatial deviation may include comparing a position of the first feature to a position of the second feature, wherein the spatial deviation may include a horizontal translation and/or a vertical translation.

In some embodiments, adjusting the combined image includes altering the alignment parameters based on the rectification parameters; and creating an updated combined image based on the altered alignment parameters.

Various aspects of the present disclosure may be implemented to use and train neural networks, decision tree-based machine models, and/or other machine learning models. Such models may be used to analyze captured image data, identify features, calculate spatial deviations, and/or generate rectification parameters and may be adjusted/updated responsive to user input and/or feedback.

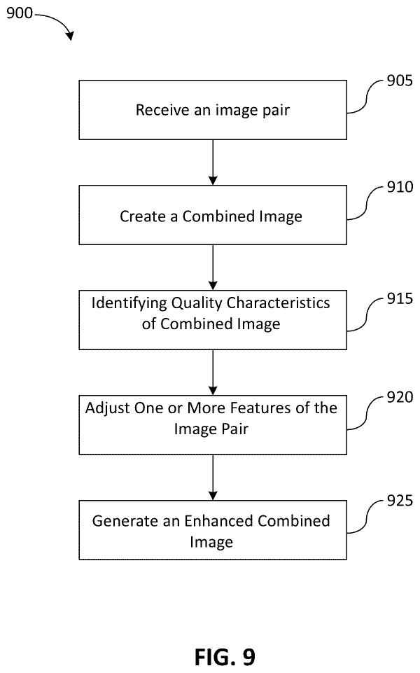

FIG. 9 illustrates a flowchart for a process 900 for generating enhanced image 832 in accordance with an embodiment of the present disclosure. For explanatory purposes, process 900 is primarily described within this disclosure with reference to system 100 and its associated arrangement of components as described in FIGS. 1-8. However, process 900 is not limited to such implementations. Any step, sub-step, sub-process, or block of process 900 may be performed in an order or arrangement different from the embodiments illustrated in FIG. 9; some may be omitted, others may be added, and some may be performed simultaneously as appropriate.

As shown in block 905, process 900 may include receiving an image pair of a scene, the image pair comprising a visible light (VIS) image of the scene captured using a VIS imaging device and an infrared (IR) image of the scene captured using an IR imaging device. For example, process 900 may include capturing a plurality of images 130 using a plurality of imaging devices 114, such as, for example, capturing one or more infrared images using an infrared imaging device and one or more visual images using a visible imaging device. In one or more embodiments, plurality of images 130 may be taken simultaneously of the same scene, such as scene 102. Logic device 104 may then be configured to receive the plurality of images 130, such as image pair 130a,b, from imaging devices 114a,b, respectively. In various embodiments, receiving image pair 130a,b may include imaging devices 114a,b transmitting image data associated with image pair 130a,b to logic device 104.

As shown in block 910, process 900 may include generating a combined image, such as combined image 732 (e.g., combined image 132, updated combined image 328, or the like), based on the image pair, such as image pair 130a,b. In one or more embodiments, generating combined image 732 may include generating combined image 132 and/or updated combined image 328, as described in FIGS. 1-6. In one or more embodiments, combined image 732 may include one or more quality characteristics. In some embodiments, combined image 732 may be generated by creating a fusion image using, for example, spatial frequency. In some embodiments, a quality characteristic may include a luminance component of combined image 732. In one or more embodiments, generating the combined image may include deriving color characteristics of the scene from the VIS image and the IR image. In several embodiments, generating and/or creating combined image 732 (also referred to herein as a “fusion image”) may include combining the plurality of images 130 captured by the plurality of imaging devices 114. To create the combined image 732, logic device 104 may apply alignment parameters (e.g., fusion parameters) to align the plurality of images 130 (e.g., first image 130a and second image 130b) relative to each other, as previously described herein in FIGS. 1-6. For example, logic device 104 may be configured to produce combined image 732 of scene 102 based on image pair 130a,b, alignment parameters, and/or rectification parameters. For example, in some embodiments, infrared imaging device 114b (e.g., infrared imaging device) may be configured to produce one or more infrared images that can be combined with visible spectrum images captured at substantially the same time to produce a high resolution, high contrast, and/or targeted contrast combined image of scene 102.

As shown in block 915, process 900 includes identifying one or more quality characteristics of combined image 732 (e.g., combined image 132, updated combined image 328, or adjusted combined image). For instance, process 900 may include comparing luminance component of combined image 732 to a luminance threshold, and determining, if the luminance component is outside of the luminance threshold, a luminance deviation element based on the comparison. In one or more embodiments, luminance component may include a plurality of intensity values, each associated with a corresponding pixel of the combined image.

As shown in block 920, process 900 includes adjusting one or more features of at least a portion of one of the images of the image pair, such as infrared (IR) image and/or visible light (VIS) image, based on one or more quality characteristics of combined image 732. In various embodiments, one or more features of at least a portion of the VIS image may include contrast, so that process 900 may include adjusting the one or more features by increasing the contrast of the at least a portion of the VIS image based on the luminance deviation element.

In one or more embodiments, adjusting the one or more features of the at least a portion of the VIS image 130a to be adjusted for contrast further includes providing a training dataset comprising low-light image inputs correlated to contrast enhancement image outputs, and training a corrective ANN using the training dataset.

In some embodiments, logic device 104 may determine the portion of one or more images of the image pair to be adjusted. For instance, process 900 may include selecting, by a feature extraction CNN, the at least a portion of the VIS image to be adjusted for contrast. In other embodiments, selection may occur by a user input on a user interface, the at least a portion of, for example, the VIS image to be adjusted for contrast. In some embodiments, the at least a portion of the VIS image may include the entire VIS image.

As shown in block 920, process 900 includes generating an enhanced combined image 832 based on at least the adjusted image, such as adjusted IR image and/or VIS image. In one or more embodiments, generating enhanced combined image 832 may include extracting high spatial frequency content from the adjusted VIS image, where the high spatial frequency content is associated with contours and/or edges within the VIS image, and combining the extracted high spatial frequency content from the VIS image with a corresponding portion of the IR image.

In one or more embodiments, captured images may be received by logic device 104 and stored in memory component 108. As previously mentioned, logic device 104 may extract from each of the captured images 130 a subset of pixel values of scene 102 corresponding to a feature (e.g., detected object, corner, edge, point, and so on). The trained inference network (e.g., a trained image classification neural network) may classify the detected object and store the result in memory component 108, a database (e.g., object database), and/or other memory storage in accordance with system preferences. In some embodiments, logic device 104 may send images or detected objects over network 118 (e.g., the Internet or the cloud) to a server system (e.g., remote device 128) for remote image classification. In various embodiments, the inference network is a trained image classification system that may be implemented in a real-time environment.

In one or more embodiments, a neural network may be used to detect one or more features of the image pair. In some embodiments, an ANN may include a special type of a deep network that can take in an input image and extract one or more features of the input image by, for example, performing a mathematical operation called convolution multiple times. Initial layers of the network may extract low level features (e.g., detecting edges, shapes, and/or the like) and subsequent layers are responsible for extracting high level features and/or finally classifying objects.

The CNN (e.g., ANNs of FIG. 8) may be trained using a labeled training dataset that include images captured from an infrared, visible light, or other type of device that corresponds to input devices and/or data input to the object detection and classification system. In some embodiments, the training dataset includes one or more synthetically generated or modified images. The training dataset may also include other input data (e.g., the output of another trained neural network or sensor data) that may be available to the system. For example, the training process may be expanded to incorporate radar data, sonar data, GPS data, and/or other data. The training may include a forward pass of the training dataset through the CNN, including feature extraction through the plurality of convolution layers and pooling layers, followed by image classification in a plurality of fully connected hidden layers and an output layer. Next, a backward pass through the CNN may be used to update the weighting parameters for nodes of the CNN to adjust for errors produced in the forward pass (e.g., misclassified objects). In various embodiments, other types of neural networks and other training processes may be used in accordance with the present disclosure. The trained CNN may then be implemented in a runtime environment to classify objects in image regions of interest. The runtime environment may include one or more implementations of the systems and methods disclosed herein.

Similar to the preprocessing operations described herein, post-processing operations may include a variety of numerical, bit, and/or combinatorial operations performed on all or a portion of an image, such as on a component of an image, for example, or a selection of pixels of an image, or on a selection or series of images. For example, post-processing operations may include adding high resolution noise to images in order to decrease an impression of smudges or other artifacts potentially present in the enhanced combined images. In one embodiment, the added noise may include high resolution temporal noise (e.g., “white” signal noise). In further embodiments, post-processing operations may include one or more noise reduction operations to reduce or eliminate noise or other non-physical artifacts introduced into the combined images by image processing, for example, such as aliasing, banding, dynamic range excursion, and numerical calculation-related bit-noise.

In some embodiments, post-processing operations may include color-weighted (e.g., chrominance-weighted) adjustments to luminance values of an image in order to ensure that areas with extensive color data are emphasized over areas without extensive color data. For example, where a radiometric component of an infrared image is encoded into a chrominance component of a combined image, a luminance component of an image, such as adjusted images 818a,b, may be adjusted to increase the luminance of areas of enhanced combined image 832 with a high level of radiometric data. A high level of radiometric data may correspond to a high temperature or temperature gradient, for example, or an area of an image with a broad distribution of different intensity infrared emissions (e.g., as opposed to an area with a narrow or unitary distribution of intensity infrared emissions). Other normalized weighting schemes may be used to shift a luminance component of enhanced combined image for pixels with significant color content. In alternative embodiments, luminance-weighted adjustments to chrominance values of an image may be made in a similar manner.

Where applicable, various embodiments provided by the present disclosure can be implemented using hardware, software, or combinations of hardware and software. Also, where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice versa.

Software in accordance with the present disclosure, such as program code and/or data, can be stored on one or more computer readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the invention. It should also be understood that numerous modifications and variations are possible in accordance with the principles of the present invention. Accordingly, the scope of the invention is defined only by the following claims.

What is claimed is:

1. A method comprising:
receiving an image pair of a scene, the image pair comprising a visible light (VIS) image of the scene captured using a VIS imaging device and an infrared (IR) image of the scene captured using an IR imaging device;
generating a combined image based on the image pair, wherein the combined image comprises one or more quality characteristics;
adjusting one or more components of at least a portion of the VIS image based on the one or more quality characteristics of the combined image; and
generating an enhanced combined image based on at least the adjusted VIS image.

2. The method of claim 1, wherein the one or more quality characteristics of the combined image comprise a luminance characteristic and the one or more components of the portion of the VIS image comprise a contrast; and
the method further comprising:
comparing the luminance characteristic of the combined image to a luminance threshold;
determining, if the luminance characteristic is outside of the luminance threshold, a luminance deviation element based on the comparing; and
wherein the adjusting the one or more components includes increasing the contrast of the portion of the VIS image based on the luminance deviation element.

3. The method of claim 2, wherein the luminance characteristic comprises a plurality of intensity values, wherein each intensity value of the plurality of intensity values is associated with a corresponding pixel of the combined image.

4. The method of claim 2, wherein the adjusting the one or more components by increasing the contrast comprises:
providing a training dataset comprising low-light image inputs correlated to contrast enhancement image outputs;
training a contrast enhancement convolutional neural network (CNN) using the training dataset; and
increasing, using the contrast enhancement CNN, the contrast of the at least the portion of the VIS image.

5. The method of claim 2, wherein the one or more quality characteristics of the combined image further comprise a noise characteristic of the combined image; and
the method further comprising:
comparing the noise characteristic of the combined image to a noise threshold;
determining, if the noise characteristic is outside of the noise threshold, a noise deviation element; and
wherein the adjusting the one or more components comprises reducing a noise level of the at least a portion of the VIS image based on the noise deviation element.

6. The method of claim 1, wherein the generating the enhanced combined image comprises:
extracting high spatial frequency content from the adjusted VIS image, wherein the high spatial frequency content is associated with contours and/or edges within the VIS image; and
combining the extracted high spatial frequency content from the VIS image with a corresponding portion of the IR image to obtain the enhanced combined image.

7. The method of claim 1, further comprising selecting, by a user input on a user interface or a feature extraction CNN, the at least the portion of the VIS image to be adjusted for contrast; and
wherein the generating the combined image comprises deriving color characteristics of the scene from the VIS image and the IR image.

8. The method of claim 1, further comprising:
identifying a first feature in the VIS image and a second feature in the IR image;
calculating a spatial deviation based on the first feature and the second feature;
generating, if the spatial deviation exceeds a predetermined threshold, rectification parameters based at least on the spatial deviation; and
adjusting the combined image based on at least the rectification parameters.

9. The method of claim 8, wherein the calculating the spatial deviation comprises comparing a position of the first feature to a position of the second feature, wherein the spatial deviation comprises a horizontal translation and/or a vertical translation.

10. The method of claim 8, wherein the generating the combined image is further based on alignment parameters; and wherein the adjusting the combined image comprises:
altering the alignment parameters based on the rectification parameters; and
updating the combined image based on the altered alignment parameters.

11. A system comprising:
a logic device configured to:
receive an image pair of a scene, the image pair comprising a visible light (VIS) image of the scene captured using a VIS imaging device and an infrared (IR) image of the scene captured using an IR imaging device;
generate a combined image based on the image pair, wherein the combined image comprises one or more quality characteristics;
adjust one or more components of at least a portion of the VIS image based on the one or more quality characteristics of the combined image; and
generate an enhanced combined image based on at least the adjusted VIS image.

12. The system of claim 11, wherein the one or more quality characteristics of the combined image comprise a luminance characteristic and the one or more components of the portion of the VIS image comprise a contrast; and
wherein the logic device is further configured to:
compare the luminance characteristic of the combined image to a luminance threshold;
determine, if the luminance characteristic is outside of the luminance threshold, a luminance deviation element based on the comparison; and
wherein the logic device is configured to adjust the one or more components by increasing the contrast of the portion of the VIS image based on the luminance deviation element.

13. The system of claim 12, wherein the luminance characteristic comprises a plurality of intensity values, wherein each intensity value of the plurality of intensity values is associated with a corresponding pixel of the combined image.

14. The system of claim 12, wherein the adjusting the one or more components by the increasing the contrast comprises:
providing a training dataset comprising low-light image inputs correlated to contrast enhancement image outputs; and
training a contrast enhancement convolutional neural network (CNN) using the training dataset; and
increasing, using the contrast enhancement CNN, the contrast of the at least the portion of the VIS image.

15. The system of claim 12, wherein:
the one or more quality characteristics of the combined image further comprise a noise characteristic of the combined image; and
the logic device is further configured to:
compare the noise characteristic of the combined image to a noise threshold;
determine, if the noise characteristic is outside of the noise threshold, a noise deviation element; and
wherein the adjusting the one or more components comprises reducing a noise level of at least a portion of the VIS image based on the noise deviation element.

16. The system of claim 11, wherein the logic device is further configured to generate the enhanced combined image by:
extracting high spatial frequency content from the adjusted VIS image, wherein the high spatial frequency content is associated with contours and/or edges within the VIS image; and
combining the extracted high spatial frequency content from the VIS image with a corresponding portion of the IR image to obtain the enhanced combined image.

17. The system of claim 11, wherein the logic device is further configured to, in response to a user input on a user interface or selection by a feature extraction CNN, the at least the portion of the VIS image to be adjusted for contrast; and
wherein the logic device is configured to generate the combined image by deriving color characteristics of the scene from the VIS image and the IR image.

18. The system of claim 11, wherein the logic device is further configured to:
identify a first feature in the VIS image and a second feature in the IR image;
calculate a spatial deviation based on the first feature and the second feature;
generate, if the spatial deviation exceeds a predetermined threshold, rectification parameters based at least on the spatial deviation; and
adjust the combined image based on at least the rectification parameters.

19. The system of claim 18, wherein the logic device is further configured to calculate the spatial deviation by comparing a position of the first feature to a position of the second feature, wherein the spatial deviation comprises a horizontal translation and/or a vertical translation.

20. The system of claim 18, wherein the logic device is further configured to generate the combined image based on alignment parameters; and wherein the logic device is further configured to adjust the combined image by:
altering the alignment parameters based on the rectification parameters; and
updating the combined image based on the altered alignment parameters.
